(19) United States
(12) Patent Application Publication
(10) Pub. No.: US 2026/0203513 A1
(43) Pub. Date: Jul. 16, 2026

(54) Real-Time Latent-Based Fusion for Multi-Camera Continuous Zoom Systems

(71) Applicant: AtomBeam Technologies Inc., Moraga, CA (US)

(72) Inventor: Brian Galvin, Silverdale, WA (US)

(21) Appl. No.: 19/385,114

(22) Filed: Nov. 10, 2025

Related U.S. Application Data
(63) Continuation-in-part of application No. 19/383,734, filed on Nov. 9, 2025.
Application No. 19/383,734 is a continuation-in-part of application No. 19/379,579, filed on Nov. 4, 2025.
Application No. 19/379,579 is a continuation-in-part of application No. 19/378,949, filed on Nov. 4, 2025.
Application No. 19/378,949 is a continuation-in-part of application No. 19/377,013, filed on Nov. 2, 2025.
Application No. 19/377,013 is a continuation-in-part of application No. 19/352,457, filed on Oct. 7, 2025.
Application No. 19/352,457 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
Application No. 19/051,193 is a continuation-in-part of application No. 19/038,801, filed on Jan. 28, 2025.
Application No. 19/038,801 is a continuation of application No. 18/818,593, filed on Aug. 29, 2024, now Pat. No. 12,308,862.
Application No. 18/818,593 is a continuation-in-part of application No. 18/657,719, filed on May 7, 2024, now Pat. No. 12,166,506.
Application No. 18/657,719 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
Application No. 19/377,013 is a continuation-in-part of application No. 19/326,730, filed on Sep. 12, 2025, now Pat. No. 12,608,555.
Application No. 19/326,730 is a continuation-in-part of application No. 19/321,173, filed on Sep. 6, 2025, now Pat. No. 12,602,549.
Application No. 19/321,173 is a continuation-in-part of application No. 19/245,366, filed on Jun. 22, 2025, now Pat. No. 12,418,680.
Application No. 19/245,366 is a continuation-in-part of application No. 19/204,525, filed on May 10, 2025.
Application No. 19/204,525 is a continuation-in-part of application No. 19/192,215, filed on Apr. 28, 2025.
Application No. 19/192,215 is a continuation-in-part of application No. 18/972,797, filed on Dec. 6, 2024, now Pat. No. 12,294,392.
Application No. 18/972,797 is a continuation-in-part of application No. 18/648,340, filed on Apr. 27, 2024, now Pat. No. 12,166,507.
Application No. 19/378,949 is a continuation-in-part of application No. 19/328,094, filed on Sep. 12, 2025, now Pat. No. 12,632,663.
Application No. 19/328,094 is a continuation-in-part of application No. 19/321,173, filed on Sep. 6, 2025, now Pat. No. 12,602,549.
Application No. 19/379,579 is a continuation-in-part of application No. 19/363,675, filed on Oct. 21, 2025.
Application No. 19/363,675 is a continuation-in-part of application No. 19/351,286, filed on Oct. 6, 2025.
Application No. 19/351,286 is a continuation-in-part of application No. 19/321,173, filed on Sep. 6, 2025, now Pat. No. 12,602,549.
Application No. 18/648,340 is a continuation-in-part of application No. 18/427,716, filed on Jan. 30, 2024, now Pat. No. 12,093,972.
Application No. 18/427,716 is a continuation-in-part of application No. 18/410,980, filed on Jan. 11, 2024, now Pat. No. 12,068,761.
Application No. 19/383,734 is a continuation-in-part of application No. 19/329,369, filed on Sep. 15, 2025.
Application No. 19/329,369 is a continuation-in-part of application No. 19/328,199, filed on Sep. 14, 2025.
Application No. 19/328,199 is a continuation-in-part of application No. 19/328,179, filed on Sep. 14, 2025.
Application No. 19/328,179 is a continuation-in-part of application No. 19/326,730, filed on Sep. 12, 2025, now Pat. No. 12,608,555.
Application No. 19/328,199 is a continuation of application No. 19/328,103, filed on Sep. 13, 2025, now Pat. No. 12,639,521.
Application No. 19/328,103 is a continuation-in-part of application No. 19/326,730, filed on Sep. 12, 2025, now Pat. No. 12,608,555.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,969, filed on Jul. 21, 2025.
(60) Provisional application No. 63/847,889, filed on Jul. 21, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method for real-time latent-based scene fusion across multiple camera feeds enables seamless navigation through unified visual representations. Video streams from multiple cameras are encoded into separate latent manifolds using Lorentzian autoencoders that preserve spatiotemporal coherence for each viewpoint. These individual manifolds are registered and fused through weighted geodesic interpolation into a unified representation where compression pressure fields reflect semantic density. Users navigate this fused space along geodesic trajectories that traverse both scale and viewpoint axes by minimizing a functional balancing kinetic energy, compression pressure, and goal potential. Cross-view correlations restore occluded regions while Bayesian fusion of geometric priors, simulated rollouts, and historical outcomes computes probabilities for reconstructing unobserved viewpoints. The system renders video by decoding latent representations along computed trajectories, synthesizing content for regions not captured by any camera when posterior probabilities exceed thresholds, enabling continuous zoom operations across multiple perspectives without perceptual discontinuities.

### CROSS-REFERENCE TO RELATED APPLICATIONS

Priority is claimed in the application data sheet to the following patents or patent applications, each of which is expressly incorporated herein by reference in its entirety:
Ser. No. 19/383,734
Ser. No. 19/379,579
Ser. No. 19/378,949
Ser. No. 19/377,013
Ser. No. 19/352,457
Ser. No. 19/321,173
Ser. No. 19/284,115
Ser. No. 19/051,193
63/847,082
63/847,091
63/847,096
63/847,101
63/847,969
Ser. No. 19/038,801
Ser. No. 18/818,593
Ser. No. 18/657,719
Ser. No. 18/410,980
Ser. No. 18/537,728
Ser. No. 19/326,730
63/847,889
Ser. No. 19/245,366
Ser. No. 19/204,525
Ser. No. 19/192,215
Ser. No. 18/972,797
Ser. No. 18/648,340
Ser. No. 19/328,094
Ser. No. 19/363,675
Ser. No. 19/351,286
Ser. No. 18/427,716
Ser. No. 19/329,369
Ser. No. 19/328,199
Ser. No. 19/328,179
Ser. No. 19/328,103

### BACKGROUND OF THE INVENTION

### Field of the Art

The present invention relates to the field of artificial intelligence and computer vision, and more specifically to systems and methods for multi-camera video fusion, continuous zoom, and predictive scene reconstruction using latent-space representations.

### Discussion of the State of the Art

Video stitching, alignment, and enhancement technologies have advanced significantly in recent years, particularly for surveillance, sports broadcasting, and mobile devices that rely on multiple cameras. Conventional approaches typically operate in pixel space, applying methods such as homography-based registration, feature matching, and blending to merge overlapping fields of view. In parallel, infinite zoom and generative enhancement techniques have been developed for single-camera systems, allowing users to zoom continuously within a single latent representation derived from autoencoders or diffusion models. These methods have demonstrated the ability to produce visually appealing transitions, but they remain constrained to single-view contexts.

Despite these advances, current systems face fundamental limitations. Pixel-level stitching often introduces parallax artifacts, seams, and occlusion gaps, especially when combining heterogeneous camera feeds with varying resolutions, orientations, and frame rates. Real-time operation at scale is difficult, since warping and blending pipelines are computationally intensive and require high bandwidth for raw video transmission. Existing infinite zoom systems remain siloed within individual cameras, preventing seamless traversal across multiple viewpoints. Furthermore, most multi-camera fusion frameworks discard semantic and temporal coherence, producing mosaics that lack the structural integrity required for predictive reconstruction or reasoning.

What is needed is a system that projects multi-camera video streams into latent space, aligns them geometrically into a unified fused manifold, and enables continuous zoom, predictive reconstruction, and federated synchronization with semantic and temporal coherence.

### SUMMARY OF THE INVENTION

Accordingly the inventor has conceived and reduced to practice a system and method for real-time fusion of multi-camera video streams in latent space, enabling continuous zoom across scale and viewpoint while preserving semantic and temporal coherence. Unlike pixel-space stitching approaches, the disclosed system operates within Lorentzian latent manifolds that capture spatiotemporal structure for each camera feed, aligning them into a unified fused manifold. This manifold supports geodesic traversal that balances kinetic energy, compression pressure, and user-directed goals, while also permitting predictive reconstruction of regions not directly captured by any camera. By combining cross-view correlations, Bayesian fusion of priors, GPU-accelerated simulations, and federated synchronization, the system delivers coherent, explainable video outputs at interactive speeds, with adaptive learning mechanisms that refine performance over time.

In an embodiment, a computer system is provided with software instructions stored on non-transitory machine-readable media that configure it to encode video streams from multiple cameras into respective latent manifolds using Lorentzian autoencoders, each manifold preserving spatiotemporal coherence for its associated camera view. The system registers these latent manifolds into a fused manifold using weighted geodesic interpolation that aligns trajectories across viewpoints. Compression pressure fields are generated within the fused manifold to represent semantic density. Geodesic trajectories through the fused manifold are computed to support continuous traversal across both scale and viewpoint, minimizing a functional that balances kinetic energy, compression pressure, and goal potential. Occluded or degraded regions are restored by leveraging cross-view correlations, and posterior probabilities for reconstructing unobserved viewpoints are computed through Bayesian fusion of geometric priors, simulated rollouts, and historical outcomes. Rendering is achieved by decoding latent representations along the computed geodesic paths, including synthesized content for regions not directly captured by any camera when posterior probabilities exceed a threshold.

In an aspect of an embodiment, the encoding process may include computing quality-of-evidence scores for each camera stream and weighting their contributions during registration according to these scores.

In an aspect of an embodiment, registration of the latent manifolds may include computing registration maps between pairs of manifolds to minimize cross-view distortion, with the process constrained by symbolic anchors that link latent states to semantic labels.

In an aspect of an embodiment, geodesic trajectory computation may include deriving compression pressure from Ricci curvature of the fused manifold so that semantically dense regions impose greater traversal costs.

In an aspect of an embodiment, posterior probabilities may be refined through GPU-parallelized rollout simulations that model short-horizon trajectories under stochastic perturbations biased toward occlusion conditions.

In an aspect of an embodiment, the fused manifold may be discretized into a landmark graph that supports efficient nearest-neighbor queries in logarithmic time for registration and traversal.

In an aspect of an embodiment, federated operation may be supported by exchanging posterior parameters and divergence indices with remote systems managing geographically distributed camera arrays, while avoiding the need to transmit raw video.

In an aspect of an embodiment, adaptive recalibration may be achieved by replaying archived geodesic trajectories during idle cycles, updating density thresholds and fusion parameters based on accumulated compression pressure.

In an embodiment, the invention may also be expressed as a computer-implemented method. The method includes encoding video streams from multiple cameras into Lorentzian latent manifolds, registering the manifolds into a fused manifold through weighted geodesic interpolation, generating compression pressure fields, computing geodesic trajectories that span scale and viewpoint, restoring occluded regions through cross-view correlations, and computing posterior probabilities for unseen viewpoints using Bayesian fusion of priors, rollouts, and historical outcomes. The method further includes rendering video outputs by decoding latent representations along geodesic trajectories, including synthesized content when posterior probabilities indicate sufficient confidence.

In an aspect of an embodiment, the method may further include computing quality-of-evidence scores for each stream and weighting them during registration, computing registration maps constrained by symbolic anchors, deriving compression pressure from Ricci curvature, and performing GPU-based rollout simulations to support posterior estimation. Additional aspects include discretizing the fused manifold into landmark graphs for efficient traversal, exchanging posterior parameters and divergence indices with federated nodes without transmitting raw video, and replaying archived trajectories during idle cycles to recalibrate thresholds and fusion parameters.

### BRIEF DESCRIPTION OF THE DRAWING FIGURES

FIG. 1 is a block diagram illustrating an exemplary system architecture for real-time multi-camera latent scene fusion, showing per-camera encoding, latent fusion, correlation and restoration, geodesic traversal, predictive scene completion, federated governance, and human interaction subsystems.

FIG. 2 is a flow diagram illustrating exemplary multi-camera encoding and registration operations, in which heterogeneous camera streams are normalized, encoded into fast manifolds, quality-scored, and registered for fusion.

FIG. 3 is a flow diagram illustrating exemplary latent fusion operations, in which registered fast manifolds are embedded into a fused manifold, trajectories are aligned by weighted geodesic interpolation, proto-scene clusters are identified, and fused alert objects are enriched with tags, provenance, and reasoning pathways.

FIG. 4 is a flow diagram illustrating exemplary geodesic traversal and continuous zoom operations, in which compression pressure and goal potential fields are computed, geodesic paths are optimized, trajectories are decoded into frames, and rendered video is output within latency bounds.

FIG. 5 is a flow diagram illustrating exemplary predictive scene completion operations, in which geometric priors, rollout simulations, and historical kernels are fused into Bayesian posteriors, gating logic determines reconstruction outcomes, and results are integrated, escalated, or suppressed.

FIG. 6 is a flow diagram illustrating exemplary federated synchronization operations, in which fiber maps transport alert objects, divergence indices are calculated and compared to autonomy envelopes, collective divergence is minimized when necessary, doctrinal compliance is enforced, and consistent alerts are output.

FIG. 7 is a flow diagram illustrating exemplary sleep-state learning and schema consolidation operations, in which archived trajectories are replayed, compression pressure is analyzed, thresholds are recalibrated, posterior parameters are updated, counterfactual trajectories are generated, and recurrent patterns are consolidated into schemas.

FIG. 8 is a flow diagram illustrating exemplary correlation network restoration operations, in which occluded regions are identified, cross-view correlations are analyzed, unoccluded perspectives are used to extract latent features, missing content is synthesized, consistency is validated, and restored regions are integrated into the fused manifold.

FIG. 9 is a flow diagram illustrating exemplary counterfactual scene expansion operations, in which perturbations in tangent space generate alternate trajectories, synthetic views are decoded, plausibility and consistency are assessed, probability estimates are computed, and counterfactual perspectives are output.

FIG. 10 is a flow diagram illustrating exemplary human interaction and feedback loop operations, in which scene fusion cards are generated with probabilities and provenance, operator input is received, trajectory-outcome pairs are stored, posterior parameters are adjusted, schemas are reinforced, and co-adapted system states are produced.

FIG. 11 is a flow diagram illustrating exemplary divergence index calculation and governance operations, in which remote alerts are transported by fiber maps, divergence indices are calculated, autonomy is preserved or reconciliation performed through distributed gradient descent, doctrinal checks are applied, and reconciled alerts are output.

FIG. 12 illustrates an exemplary computing environment on which an embodiment described herein may be implemented.

### DETAILED DESCRIPTION OF THE INVENTION

The inventor has conceived and reduced to practice a system and method are provided for real-time latent-based scene fusion across multiple camera feeds within continuous zoom architectures. Operating in latent space rather than pixel space, the system may reduce parallax artifacts and occlusion gaps through geometric operators. Traversal across both scale and viewpoint axes can support unified zoom capabilities that were previously siloed. Predictive completion using Bayesian fusion of multiple evidence sources may allow the system to infer unobserved content in addition to stitching available feeds. Federated governance using divergence indices and collective minimization can maintain consistency across distributed deployments without requiring centralization of sensitive data. Adaptive learning through sleep-state replay and dreaming may improve performance over time. Together, these innovations transform multi-camera monitoring from fragmented pixel mosaics into unified cognitive manifolds that support substantially seamless real-time situational awareness.

Raw video streams from heterogeneous cameras are normalized and encoded using Lorentzian autoencoders into per-camera fast manifolds, each preserving spatiotemporal coherence with quality-weighted evidence scores. These latent representations are then registered and fused via weighted geodesic interpolation into a unified mesoscale manifold, where kernel density estimation detects proto-scene clusters that are projected into enriched alert objects with doctrinal tags and provenance metadata. A correlation network can enhance this fused manifold by exploiting cross-view redundancies to restore occluded regions and synthesize missing details. A predictive completion engine may combine geometric reachability priors, GPU-parallelized rollout simulations, and historical kernel estimates in a Bayesian framework to generate plausible reconstructions of unobserved viewpoints. Users navigate this fused cognitive space through continuous zoom operations that minimize a cognitive action functional balancing kinetic energy, compression pressure from local curvature, and goal potential fields.

A plurality of video streams from N cameras with heterogeneous resolutions and fields of view can be processed by a system configured to normalize and encode the streams into latent representations. Each camera stream may be denoted xi(t) for camera i at time t. A video input normalizer is configured to handle heterogeneous streams with different resolutions, frame rates, and spectral ranges. A normalization process Ni applies resolution scaling, temporal alignment, and radiometric calibration to each stream.

A Lorentzian autoencoder bank includes one or more encoders, with an encoder Ei associated with each camera i. Each encoder is configured to produce a latent trajectory that can be expressed as:

$$zi ( t ) = Ei ( Ni ( xi ( t ) ) )$$

where zi(t) represents an encoded state in a fast manifold Mi¹ associated with that camera. A fast manifold preserves spatiotemporal coherence via time-like latent axes and three-dimensional convolutional encoders. The time-like latent axes can be used to preserve temporal ordering and causal structure within encoded representations.

A quality annotator may compute evidence scores for each encoded stream to characterize the reliability of its latent representation. An evidence score qi(t) can capture factors such as encoder fidelity, signal quality, or noise conditions at time t for a given camera i. By attaching these scores to encoded trajectories, the system can weight contributions during fusion, allowing stronger signals to dominate while weaker or noisier inputs have proportionally less influence. This weighting improves the robustness of the fused manifold, particularly in heterogeneous environments where cameras differ in resolution, frame rate, or lighting conditions.

To preserve coherence across video streams, a fast manifold manager maintains the per-camera latent manifolds produced by Lorentzian encoders. Each fast manifold Mi¹ is treated as a geometric structure in latent space where distances and paths correspond to perceptual and semantic relationships within the content of a single camera. By maintaining these structures independently before fusion, the manager ensures that temporal ordering, causal consistency, and spatial relationships are preserved within each individual stream, preventing distortion or loss of context during subsequent alignment.

A latent fusion engine then registers and aligns the fast manifolds from multiple cameras into a shared mesoscale manifold. This engine implements a collection of functional components—including registration operators, geodesic interpolators, and density estimators—that work together to produce unified scene representations. The resulting mesoscale manifold provides a coherent space in which multi-camera data can be traversed continuously, supporting downstream operations such as correlation-based restoration, predictive completion, and interactive zooming across scale and viewpoint.

A registration engine computes registration maps between pairs of fast manifolds to align their geometric structures. A registration map Rij mapping from manifold Mi¹ to manifold Mj¹ may minimize cross-view distortion according to an expression such as:

$$Rij = arg min R \sum t {{dMj}^{1} ( R ( zi ( t ) ) , zj ( t ) )}^{2}$$

where dMj¹ represents a distance metric in manifold Mj¹. Registration can be constrained by symbolic anchors and known camera geometry, producing consistent cross-view correspondences. Symbolic anchors are semantic labels or tags associated with specific features or objects that provide reference points for alignment across different camera views.

A weighted geodesic interpolator implements a fusion operator F configured to align latent trajectories across viewpoints. A fusion operator F: {Mi¹}^{N}i=1→M2 may map a collection of N fast manifolds into a single mesoscale manifold M2. A fused trajectory can be computed according to an optimization such as:

$$zf ( t ) = arg min z ∈ M 2 {\sum }^{N} i = 1 wi dM 2 {( z , φ i ( zi ( t ) ) )}^{2}$$

where φi represents an isometric embedding of fast manifold Mi¹ into mesoscale manifold M2, wi represents a weight proportional to quality score qi(t), and dM2 represents a geodesic distance in M2. Geodesic distance refers to the shortest path within a curved geometric space, analogous to great-circle distances on a sphere but generalized to higher-dimensional latent manifolds. This weighted optimization yields fused trajectories that integrate information from multiple camera perspectives into coherent scene manifolds.

A density estimator is configured to detect proto-scene clusters using kernel density estimation in mesoscale manifold M2. A density function may be expressed as:

$$ρ ( z ) = {\sum }^{N} i = 1 \sum t K ( z , φ i ( zi ( t ) ) )$$

where K represents a kernel function. A kernel function may take the form:

$$K ( z , y ) = exp ( - dM 2 {( z , y )}^{2} / 2 {σ}^{2} )$$

where σ represents a bandwidth parameter controlling the spatial extent of density contributions. Clusters that exceed density thresholds form proto-scene objects representing regions where multiple camera views converge on similar latent representations.

A projection engine projects proto-scene clusters into mesoscale manifold M2 via a projection operator. A projection operator π: {Mi¹}→M2 maps collections of fast manifold states into mesoscale manifold states. Each fused alert object Am may be expressed as Am=π(Ap), where Ap represents a proto-scene cluster. Fused alert objects are enriched with doctrinal tags, provenance metadata, and reasoning pathways Φ. Doctrinal tags encode policy constraints, operational guidelines, or semantic classifications. Provenance metadata tracks which cameras and time intervals contributed to each fused object. Reasoning pathways Φ capture logical dependencies and inference chains supporting object classifications.

A correlation network enhances fused manifold representations by exploiting redundancies between camera views. A correlation network C may implement a function:

$$\hat{z} f ( t ) = C ( zf ( t ) , {\{ zi ( t ) \}}^{N} i = 1 )$$

where zf(t) represents a fused trajectory and {zi(t)}^{N}i=1 represents a collection of per-camera latent states. A cross-view correlation analyzer identifies redundancies between camera views, enabling information captured by one camera to inform reconstruction of regions occluded or degraded in another camera.

An occlusion handler restores hidden regions using multi-view geometry and cross-camera correlations. When one camera view is occluded by foreground objects or environmental conditions, the correlation network leverages information from other camera views to infer plausible content in the occluded regions. This restoration operates in latent space, maintaining geometric consistency with observed portions of a scene.

A detail synthesizer may generate plausible missing information to support visual continuity during zoom transitions. When zooming beyond the original camera resolution or into regions not directly observed by any camera, the synthesizer can create synthetic details that remain consistent with the semantic and geometric context of surrounding content. To maintain coherence, a coherence validator checks restored content across viewpoint transitions. As users navigate between different camera perspectives, the validator verifies that synthesized or restored regions do not introduce perceptual discontinuities or semantic contradictions.

A geodesic traversal engine enables continuous navigation through fused scene manifolds across both scale and viewpoint dimensions. Scene navigation is represented as geodesic trajectories in mesoscale manifold M2, parameterized by a zoom variable that spans these axes. A multi-axis path planner computes such geodesics. A geodesic trajectory γ(s) may be parameterized by a zoom variable s, and an optimal trajectory may be determined according to an optimization such as:

$$γ ( s ) = arg min γ {\int }_{0}^{1} ( {‖ \dot{γ} ( s ) ‖}^{2} g 2 + P ( γ ( s ) ) - Φ ( γ ( s ) ) ) ds *$$

In this formulation, ∥\dot{γ}(s)∥²g2 represents kinetic energy of attention motion within manifold M2 according to a Riemannian metric g2, P(γ(s)) represents compression pressure derived from local curvature, and Φ(γ(s)) encodes a goal potential derived from user zoom requests.

A compression pressure field computer derives compression pressure from curvature characteristics of mesoscale manifold M2. Compression pressure may be related to Ricci curvature, which measures how volumes in a curved space deviate from those in a flat space. High compression pressure corresponds to semantically dense regions where information is tightly packed, making traversal more demanding, while low compression pressure corresponds to sparser regions that permit easier navigation. Complementing this, a goal potential field generator encodes user-specified regions R and scales α as attractive potential fields. These fields bias traversal toward user-specified targets while respecting the geometric structure of the underlying manifold.

A trajectory optimizer minimizes the cognitive action functional that combines kinetic energy, compression pressure, and goal potential. By balancing these factors, the optimizer produces trajectories that provide efficient navigation while accommodating the perceptual effort required to traverse regions of varying semantic density. Resulting trajectories yield smooth transitions across scale and perspective without perceptual discontinuities. A real-time decoder then renders views along the computed paths, transforming latent-space geometric structures back into observable pixel-space outputs. Decoding may employ generative models configured to synthesize high-resolution imagery from latent representations, potentially exceeding the resolution of original camera feeds by leveraging learned priors about natural image statistics.

A predictive completion engine may further synthesize views not directly captured by any camera. This enables zoom into occluded or unmonitored regions, filling perceptual gaps with reconstructions that are statistically and geometrically consistent with the scene. A geometric prior computer calculates reachability priors to estimate the feasibility of such reconstructions based on manifold geometry. A geometric reachability prior for reconstruction policy π at initial state x0 may be expressed as:

$$φπ ( x 0 ) = σ ( - α d π ( x 0 , S ) - β κπ ( γ ) - γ C ( x 0 ) )$$

where σ represents a logistic map, dπ(x0,S) is the policy-aligned geodesic distance from x0 to hidden region S, κπ(γ) accumulates geodesic curvature along trajectory γ under policy π, and C(x0) represents compression pressure at x0. Parameters α, β, and γ weight the relative contributions of distance, curvature, and compression. Larger distances, higher curvatures, and greater compression pressures reduce the estimated probability of successful reconstruction, providing a structured measure of feasibility.

A GPU rollout engine may simulate short-horizon trajectories in parallel to evaluate reconstruction feasibility. Rollouts can follow dynamics such as:

$$xt + Δ t = xt + Δ t \hat{F} ( xt , u π ( xt ) ) + η t$$

where \hat{F} represents a transition operator learned from multi-camera dynamics, uπ represents a control field induced by policy π, and ηt represents stochastic perturbations drawn from a distribution such as ηt~N(μ(xt), Σ(xt)). Perturbations may be biased toward occlusion or adversarial conditions to probe the robustness of reconstructions. Each rollout terminates in success or failure, yielding Bernoulli outcomes with importance weights wi. By exploiting GPU parallelization, the system may simulate hundreds or thousands of candidate trajectories within milliseconds, providing a rich body of empirical evidence regarding reconstruction plausibility.

To complement real-time rollouts, a historical kernel estimator weights past outcomes by similarity to current contexts. A historical probability estimate may be expressed as:

$${\hat{p}}^{hist} π ( x 0 ) = [ \sum i K ( x 0 , xi ) S ( π , π i ) yi ] / [ \sum i K ( x 0 , xi ) S ( π , π i ) ]$$

where (xi, πi, yi) represents historical outcomes consisting of state xi, policy πi, and binary outcome yi; K measures geodesic similarity between states; and S measures policy similarity.
This estimator captures recurring occlusion patterns and typical reconstruction results in similar environments, enabling the system to leverage accumulated experience when predicting outcomes for new scenarios.

A Bayesian fusion engine then combines evidence sources into a posterior distribution over reconstruction success. A posterior may follow a Beta distribution such as pπ(x0)~Beta(α, β), where α and β represent shape parameters. The posterior mean can be computed as \hat{p}π(x0)=α/(α+β). Parameters are initialized by geometric priors, updated by rollout evidence through the addition of successes to α and failures to β, and adjusted by historical likelihoods through Bayesian updating. Posterior quantiles define credible intervals characterizing uncertainty in the probability estimates. For instance, the 5th and 95th percentiles may define a 90% credible interval, which informs whether automatic reconstruction, human escalation, or suppression is most appropriate.

The system may also include a counterfactual generator that synthesizes alternate viewpoints by perturbing fused trajectories. Given a fused trajectory γ(t) in mesoscale manifold M2, perturbations δ in tangent space Tγ(t)M2 yield alternate paths according to:

$${γ}^{′} ( t ) = γ ( t ) + δ$$

Perturbed trajectories are decoded into synthetic perspectives representing behind-object completions, hypothesized camera angles not physically present, or interpolated scene expansions filling gaps between camera coverage areas. To manage outputs, gating logic determines whether to auto-complete, escalate, or suppress reconstructions based on posterior thresholds. Reconstructions with posterior probabilities exceeding an upper threshold may be automatically integrated into fused scene representations, while those falling below a lower threshold may be suppressed to avoid unreliable outputs. Intermediate probabilities can trigger escalation to human operators for review and approval.

In distributed deployments, multiple PCM instances may perform scene fusion concurrently. Governance mechanisms are configured to maintain consistency across the federation while preserving local autonomy and privacy. A fiber map manager manages mappings that transport alert objects and fused trajectories across PCM nodes. For example, a fiber map Fkl: Ml²→Mk² may project representations from mesoscale manifold Ml² at node l into mesoscale manifold Mk² at node k. Fiber maps enable shared situational cognition across distributed systems without requiring the exchange of raw video streams, thereby preserving bandwidth and protecting privacy.

A divergence index calculator may compute divergence indices that quantify cross-node semantic drift. For an alert object A, a divergence index can be expressed as:

$$Dkl ( A ) = {dMk}^{2} ( Fkl ( Al ) , Ak )$$

where Al represents an alert or scene object in manifold Ml² and Ak represents the corresponding object in manifold Mk². Divergence measures how much transported representations differ from those computed locally. An autonomy envelope monitor tracks divergence against acceptable thresholds. If Dkl(A) remains below a threshold ϵkl, local autonomy is preserved and nodes operate independently. When divergence exceeds the threshold, reconciliation procedures are triggered. Governance can be achieved by minimizing a collective divergence functional, which may take the form:

$$Cfed = \sum ( k , l ) wkl {Dkl ( A )}^{2}$$

where weights wkl reflect trust relationships, network topology, or doctrinal priorities. Distributed gradient updates, such as Ak←Ak−η∇Ak Cfed, align alert semantics across the federation, where η represents a learning rate.

When autonomy envelopes are exceeded, a supervisory manifold may enforce doctrinal constraints by projecting alerts into constraint manifolds. For example, supervisory manifold M3 can enforce reconciliation by applying:

$$A = π C ( A ) *$$

where πC represents projection onto a constraint manifold C ⊂ M2. This projection embeds policy requirements such as safety overrides, human-in-loop involvement, or classification constraints. A federated synchronization protocol supports these operations by exchanging posteriors, doctrinal tags, and divergence metrics without transmitting raw video. Synchronization cycles may execute in less than 200 milliseconds across wide-area networks. Exchanged data includes posterior parameters (α, β), doctrinal tags identifying policy-relevant classifications, and divergence metrics quantifying cross-node consistency.

Over longer timescales, a schema consolidation engine builds patterns at the slow manifold level M3, where recurrent motifs compress into reusable schemas Σ. These schemas represent learned structural regularities, such as typical occlusion patterns in corridor surveillance or characteristic motion dynamics in sports venues. Complementing this, a symbolic anchor system annotates fused trajectories with semantic tags to enable bi-directional retrieval and semantic queries. Symbolic anchors may be represented as A={(tj, sj)}, where tj is a time point and sj is a semantic label. Labels such as “goalpost” or “suspect vehicle” can be linked to latent states, enabling queries such as “retrieve all trajectories passing near goalpost” or “find intervals where a suspect vehicle appeared in a fused scene.” Symbolic anchors also provide integration points with PCM thought caches, allowing fused visual representations to participate in broader cognitive reasoning processes. For instance, a PCM instance tasked with analyzing game strategy may query symbolic anchors to retrieve visual evidence of past plays involving specific field positions.

Learning and adaptation may occur during idle cycles through a sleep and learning system that replays trajectories, updates thresholds, consolidates schemas, and synthesizes counterfactual multi-camera fusions. A trajectory replay engine replays archived fused trajectories geodesically. Given archived trajectories A={(γi, yi)}, where γi: [0, Ti]→M2 represents a fused scene path and yi represents a reconstruction outcome, replay can compute geodesics such as:

$$γ ( t ) = arg min γ ∈ Γ ( γ i ( 0 ) , γ i ( Ti ) ) {\int }_{0}^{Ti} {‖ \dot{γ} ( t ) ‖}^{2} g dt *$$

where Γ(γi(0), γi(Ti)) denotes the space of paths connecting the initial and final states of the archived trajectory γi. This condensation into minimal-action summaries reveals redundancies, anomalies, and alignment patterns that may not be apparent during real-time processing.

A threshold recalibrator adapts alert and fusion thresholds based on compression pressure within mesoscale manifold M2. Compression pressure for a region U ⊂ M2 may be computed as:

$$C ( U ) = \int U divg 2 ( \sum j \dot{x} j / ‖ \dot{x} j ‖ ) d μ$$

where divg2 represents divergence with respect to metric g2, \dot{x}j represents velocity vectors, and dμ represents a volume measure. High compression pressure can indicate over-fused or noisy regions, prompting increases in the density threshold ρcrit or fusion threshold Δfusion to suppress spurious alerts. Conversely, regions with low density and high curvature may receive lower thresholds to capture subtle correlations that would otherwise be missed.

A posterior archive updater evolves posterior parameters using archived outcomes. Updates may be expressed as:

$$α ← α + \sum i w ( γ i ) yi$$

$$β ← β + \sum i w ( γ i ) ( 1 - yi )$$

where weights w(γi) measure geodesic similarity between archived trajectory γi and current operating contexts. This process ensures that predictive completion adapts to long-run statistics accumulated across many fusion episodes, improving stability and accuracy over time.

To extend scene understanding, a cross-view recombination component implements dreaming operations at slow manifold M3. Recurrent motifs may consolidate into schemas, which can be expressed as:

$$\sum = \int A K ( γ , {γ}^{′} ) d μ ( {γ}^{′} )$$

where kernel K weights structural similarity and integration is performed over archived trajectories A. Dreaming recombines archived trajectories using stochastic processes such as γdream(t)~G(γ1, γ2, . . . ), where G represents a stochastic geodesic recombinator. The resulting trajectories represent counterfactual fusions, such as interpolations between UAV and ground camera views, which densify the latent structure and enhance generalization to novel viewpoints.

Human interaction is supported through interfaces that present structured alerts with posterior probabilities, provenance information, and interactive controls for zoom operations. A scene fusion card generator may create structured cards for each fused alert, including posterior probability \hat{p}π(x0) with credible intervals [q [symbol] , qu], provenance traces listing contributing cameras {i} with encoder confidences qi(t), fused view snapshots with overlays marking high-curvature regions, doctrinal tags such as “safety-critical” or “adversary-possible,” and recommended operator actions such as “zoom-in” or “accept auto-completion.” A credible interval visualizer displays posterior uncertainty as probability bars with mean \hat{p}π and shading to represent percentile ranges, such as the 5th to 95th percentiles. This visualization communicates epistemic uncertainty directly, distinguishing between high-confidence auto-mitigation scenarios and ambiguous cases requiring operator review.

Interaction with fused manifolds may also be achieved through an interactive zoom controller, which supports pinch or slider controls for magnification, drag or directional input for cross-camera transitions, and overlays of symbolic anchors that remain consistent across zoom levels. Latency is bounded to less than 100 milliseconds to ensure responsiveness. A counterfactual explainability engine generates what-if visualizations by perturbing trajectories. Given a trajectory γ(t), perturbations δ in tangent space Tγ(t)M2 produce alternate trajectories:

$${γ}^{′} ( t ) = γ ( t ) + δ$$

which are decoded and displayed alongside provenance and probability estimates. This allows operators to explore alternative perspectives or visualize occluded regions.

The system further incorporates a human-PCM feedback loop, reintegrating operator decisions into manifold representations. When a scene fusion card is presented, the operator may accept a recommendation, override it with an alternative classification, or annotate it with additional context. PCM then updates its archives with a trajectory-outcome pair (γ, y), adjusts posterior parameters α and β, and reinforces relevant schemas within slow manifold M3. This feedback loop supports continuous co-adaptation between human and machine cognition.

For efficient computation, fused manifold M2 may be discretized into a landmark graph G=(V, E). Vertices v ε V correspond to fused latent states, and edges (v, w) are annotated with geodesic length dvw derived from metric g2, curvature penalty κvw from local connection coefficients, and compression cost cvw from divergence of replayed trajectories. This graph structure supports O(log n) nearest-neighbor queries for fusion, registration, and divergence checks using approximate nearest-neighbor indexing algorithms.

Rollout simulations may be parallelized across GPU threads to accelerate reconstruction feasibility analysis. Rollouts can follow dynamics such as:

$$xt + Δ t = xt + Δ \hat{tF} ( xt , u π ( xt ) ) + η t$$

where \hat{F} represents a learned transition kernel and ηt represents stochastic perturbations. Warp-level summations accumulate weighted Bernoulli outcomes for Bayesian updating, allowing efficient statistical aggregation across threads. Modern GPUs can execute hundreds of rollouts per millisecond, supporting posterior refresh rates on the order of tens of milliseconds, with sub-50 millisecond updates achievable under typical workloads.

To maintain privacy while preserving consistency, PCM instances may exchange compressed summaries rather than raw video data. Exchanged information can include posterior deltas such as (Δα, Δβ), representing changes in Beta distribution parameters; divergence indices Dij quantifying cross-node consistency; and doctrinal tags with provenance hashes to enable forensic auditability. This correlation-aware federation allows distributed PCM nodes to maintain coherent fused cognition while minimizing bandwidth usage and protecting sensitive inputs.

End-to-end processing cycles are constrained to achieve real-time responsiveness. Proto-scene clustering may employ O(log n) approximate nearest-neighbor queries. Rollout and posterior updates leverage embarrassingly parallel GPU execution, while divergence governance employs distributed gradient descent to minimize the collective divergence functional Cfed. Together, these optimizations yield sub-100 millisecond latency per zoom and fusion cycle. Scalability is supported by partitioning workloads between edge encoders, which perform initial video normalization and encoding, and supervisory PCM layers operating in the cloud, which perform high-level reasoning and governance.

A representative method for multi-camera scene fusion may begin with input normalization and encoding. Each camera stream xi(t) undergoes normalization Ni, applying resolution scaling, temporal alignment, and radiometric calibration. Normalized streams are then encoded according to:

$$zi ( t ) = Ei ( Ni ( xi ( t ) ) )$$

producing latent trajectories in fast manifolds Mi¹. These encodings preserve modality-specific properties while mapping into Lorentzian latent manifolds.

Once encoded, latent registration aligns fast manifolds across views. Registration maps Rij: Mi¹→Mj¹ are computed to minimize cross-view distortion, for example:

$$Rij = arg min R Σ t {{dMj}^{1} ( R ( z i ( t ) ) , zj ( t ) )}^{2}$$

where dMj¹ represents a distance metric in manifold Mj¹. Registration may be constrained by symbolic anchors and known camera geometry.

Following registration, proto-scene fusion combines the aligned trajectories into clusters. A density estimator computes densities such as:

$$ρ ( z ) = {Σ}^{N} i = 1 Σ t K ( z , φ i ( zi ( t ) ) )$$

with kernel functions such as K(z, y)=exp(−dM2(z, y)²/2σ²). Regions exceeding density thresholds form proto-scene objects representing candidate fused alerts. Projection into the fused manifold maps proto-scene clusters using a projection operator π: {Mi¹}→M2, producing fused alert objects Am=π(Ap). These alerts may be enriched with doctrinal tags, provenance metadata identifying contributing cameras and time intervals, and reasoning pathways Φ capturing logical dependencies.

Scene traversal then implements continuous zoom operations in response to user requests. For example, a user may specify region R and scale α. Geodesic paths through M2 are computed according to:

$$γ ( s ) = arg min γ {\int }_{0}^{1} ( {‖ \dot{γ} ( s ) ‖}^{2} g 2 + P ( γ ( s ) ) - Φ ( γ ( s ) ) ) {ds}^{*}$$

balancing kinetic energy, compression pressure, and goal potential. When zoom operations exceed the resolution of the original recordings, generative augmentation synthesizes additional detail.

Divergence checks are performed to ensure federated consistency. Divergence indices Dkl are computed on shared alerts, and when values exceed autonomy envelopes, alerts may be escalated to supervisory manifolds where doctrinal constraints are enforced. Sleep-state recalibration supports long-term stability by replaying fused trajectories to update parameters such as ρcrit and Δfusion, refining kernel bandwidth σ, and executing dreaming operations that recombine multi-camera bundles to synthesize plausible cross-view continuations, thereby densifying manifold structure for future use.

A method for predictive scene completion may begin with the computation of geometric reachability priors. For a current latent state x0 and reconstruction policy π, a geometric prior may be expressed as:

$$φπ ( x 0 ) = σ ( - α d π ( x 0 , S ) - β κπ ( γ ) - γ C ( x 0 ) )$$

This formulation quantifies feasibility based on geodesic distance dπ(x0,S) to a hidden region S, accumulated curvature κπ(γ) along trajectory γ, and compression pressure C(x0) at x0. Parameters α, β, γ weight the relative contributions of distance, curvature, and compression. Larger distances, higher curvature, and greater compression pressure reduce the estimated likelihood of successful reconstruction.

Dynamic plausibility is further estimated through latent rollout simulation. Short-horizon rollouts follow dynamics such as:

$$xt + Δ t = xt + Δ t \hat{F} ( xt , u π ( xt ) ) + η t$$

where \hat{F} is a learned transition operator, uπ represents a control field induced by policy π, and ηt represents stochastic perturbations. Each rollout terminates in success or failure, yielding Bernoulli outcomes with importance weights. Historical kernel estimation then leverages past outcomes to refine predictive accuracy. A probability estimate may be expressed as:

$${\hat{p}}^{hist} π ( x 0 ) = [ Σ iK ( x 0 , xi ) S ( π , π i ) yi ] / [ Σ iK ( x 0 , xi ) S ( π , π i ) ]$$

where (xi, πi, yi) are historical outcomes consisting of a state, policy, and binary success/failure result; K measures geodesic similarity between states; and S measures similarity between policies. This estimator captures recurring occlusion patterns and typical reconstruction outcomes in comparable environments.

Evidence from priors, rollouts, and historical kernels may then be fused using a Bayesian framework. Posterior distributions such as pπ(x0)~Beta(α, β) are initialized by geometric priors, updated by rollout outcomes (successes added to α, failures added to β), and adjusted by historical likelihoods. The posterior mean \hat{p}π(x0)=α/(α+β) provides a central probability estimate, while posterior quantiles define credible intervals, for example the 5th-95th percentiles. Based on these intervals, counterfactual scene expansion can generate alternate views. Given a fused trajectory γ(t), perturbations δ in tangent space Tγ(t)M2 yield:

$${γ}^{′} ( t ) = γ ( t ) + δ$$

which can be decoded into synthetic perspectives, including behind-object completions or interpolated viewpoints. Gating logic determines disposition: reconstructions above an upper probability threshold are auto-completed and integrated into the fused scene; those below a lower threshold are suppressed; and intermediate cases are escalated to human operators for review.

A method for federated scene fusion governance may begin with fiber-coupled manifold alignment. Fiber maps such as Fij: Mj²→Mi² transport alert objects and fused trajectories across PCM nodes, enabling shared cognition without exchanging raw video. Divergence monitoring then quantifies cross-node consistency. Divergence indices, for example Dij(A)=dMi²(Fij(Aj), Ai), measure semantic drift between transported and locally computed objects. Divergence values below a threshold ϵij preserve local autonomy, while values above the threshold trigger reconciliation.

To realign semantics across the federation, collective divergence minimization may be applied. A functional such as:

$$Cfed = Σ ( i , j ) wij {Dij ( A )}^{2}$$

is minimized through distributed gradient updates, e.g., Ai←Ai−η∇Ai Cfed, with weights wij reflecting trust, topology, or doctrinal priorities. Autonomy envelope enforcement ensures policy compliance by projecting alerts into constraint manifolds when divergence exceeds tolerances. For instance, supervisory manifolds M3 may apply:

$$A = π {C ( A )}^{*}$$

where πC projects onto constraint manifold C ⊂ M2, embedding requirements such as safety overrides, human-in-loop constraints, or classification rules. Governance may also include counterflow detection, identifying adversarial perturbations that increase divergence across nodes. Counterflow fields a(x) elevate divergence indices, and governance mechanisms may dynamically tighten autonomy envelopes to prevent cascades of inconsistency.

A method for adaptive learning during sleep cycles further refines the system. Archived trajectories A={(γi, yi)} can be replayed geodesically according to:

$$γ ( t ) = arg min γ ∈ Γ ( γi ( 0 ) , γ i ( Ti ) ) {\int }_{0}^{T i} {‖ \dot{γ} ( t ) ‖}^{2} g d {t}^{*}$$

producing minimal-action summaries that expose redundancies, anomalies, and structural patterns not visible in real time. Threshold recalibration is performed using compression pressure; for example,

$$C ( U ) = \int Udivg 2 ( Σ jxj / ‖ xj ‖ ) d μ$$

where high pressure raises thresholds to suppress spurious alerts, and low pressure lowers thresholds to capture subtle correlations. Posterior archive updating may evolve parameters through:

$$α ← α + Σ i w ( γ i ) yi$$

$$β ← β + Σ iw ( γ i ) ( 1 - yi )$$

where weights reflect geodesic similarity to current contexts, ensuring predictive completion adapts to long-run statistics. Schema consolidation at slow manifold M3 compresses recurring motifs into reusable schemas, which may be expressed as:

$$Σ = \int AK ( γ , {γ}^{′} ) d μ ( {γ}^{′} )$$

capturing structural regularities such as recurring occlusion patterns or motion signatures. Finally, cross-view recombination during dreaming synthesizes counterfactual fusions. Stochastic geodesic recombination, such as γdream(t)~G(γ1, γ2, . . . ), generates interpolants between archived trajectories—for example, blending UAV and ground perspectives. Coherent interpolants with low compression cost and high reconstruction fidelity are retained, enriching the latent structure and supporting generalization to novel scenarios.

The disclosed system may transform multi-camera monitoring from pixel mosaics into cognitive manifolds. In this approach, scenes are fused rather than stitched, reducing parallax artifacts and occlusion gaps through latent-space geometric operators. Zoom operations can be performed continuously across both perspective and scale axes, enabling fluid traversal without perceptual discontinuities. Occluded and unmonitored views are reconstructed using Bayesian fusion of geometric priors, GPU-parallelized rollouts, and historical archives, thereby extending beyond passive fusion toward predictive augmentation.

Real-time operation is supported through landmark graph discretization that enables O(log n) queries, GPU rollout engines that perform parallel frame reconstruction, and federated posterior synchronization that optimizes bandwidth usage. These design choices help maintain end-to-end latency below approximately 100 milliseconds, allowing responsive continuous zoom in live applications. Federated consistency across distributed PCM nodes is maintained by divergence indices and collective divergence minimization, ensuring doctrinal coherence without requiring the centralization of raw video. Adaptive learning through sleep-state replay and dreaming allows thresholds to be recalibrated, redundancy to be reduced, and schemas to be synthesized, leading to progressive improvement over time.

The system also emphasizes explainability. Scene fusion cards may present posterior probabilities with credible intervals, provenance traces that identify contributing cameras and confidence scores, counterfactual visualizations that explore alternative perspectives, and interactive feedback loops that allow human-PCM co-adaptation. These mechanisms provide structured transparency, helping to foster operator trust and enable informed decision-making.

Applications span multiple domains. In surveillance and security contexts, citywide camera grids may be processed by PCM encoders, enabling operators to zoom seamlessly from regional overviews to individual subjects. Predictive reconstruction can fill occluded views behind buildings or vehicles, while divergence indices allow federated law enforcement nodes to reconcile alerts across jurisdictions without sharing raw video, preserving privacy through latent-space synchronization.

In sports and entertainment venues, distributed camera arrays may fuse into navigable manifolds that allow fans or analysts to zoom from stadium-wide views to detailed player close-ups, traversing across cameras without seams or stitching artifacts. Predictive completion can generate plausible views in regions lacking direct coverage, such as areas blocked by scoreboard structures or crowd occlusions. Symbolic anchors can track players and equipment across viewpoints, supporting semantic queries such as “show all possessions by player 23,” which may automatically compile relevant multi-camera segments.

In defense, intelligence, surveillance, and reconnaissance operations, UAV and ground feeds may be projected into fused manifolds that support continuous zoom from theater-scale overviews spanning kilometers down to tactical details at centimeter resolution. Counterfactual expansions can reconstruct behind-object perspectives, supporting mission planning and anomaly detection. Federated governance may ensure consistent threat assessments across distributed command nodes, while autonomy envelopes allow for localized tactical adaptation. Sleep-state dreaming can further synthesize reconnaissance coverage for unmonitored regions based on geometric priors and archived patterns.

In industrial monitoring settings such as factories or oilfields, distributed camera networks can be fused to provide predictive maintenance and safety insights. Operators may zoom into equipment from multiple perspectives to check for wear or damage, while correlation networks help reconstruct views that would otherwise be obscured by steam, dust, or structural barriers. Over time, dreaming routines may distill recurring patterns into schemas that signal early indicators of failure, such as characteristic vibration signatures or thermal anomalies, enabling proactive repairs rather than reactive interventions.

Consumer devices offer another application. Modern smartphones often employ multiple lenses with different focal lengths or spectral sensitivities. By fusing these inputs in real time, the system can deliver perceptually consistent zooming that goes beyond the resolution of any single lens. In low-light or occluded scenes, predictive completion may introduce missing details, enhancing image quality without relying on larger physical sensors. Users may also search their photo libraries semantically: for instance, a query such as “find all images containing red flowers” could be executed against latent representations rather than simple pixel-level pattern matching, yielding richer and more accurate results.

The encoder stage itself is flexible and can be tailored to different operational needs. Some implementations may rely on three-dimensional convolutional neural networks that preserve spatiotemporal structure, while others use recurrent designs such as long short-term memory networks to capture temporal dependencies. Transformer-based architectures with attention mechanisms are also suitable, particularly when higher-resolution feeds demand deeper encoders capable of recognizing fine semantic distinctions.

Alignment of fast manifolds can be approached in several ways. Rigid registration maintains camera geometry through rotation and translation, while affine methods extend this with scaling or shearing. For cases requiring more elasticity, diffeomorphic registration provides smooth deformations that avoid folding or tearing. Depending on availability, the registration process may incorporate explicit camera calibration parameters such as intrinsic and extrinsic matrices, or alternatively depend on learned latent correspondences when calibration is unavailable.

Fusion of latent trajectories does not need to be limited to weighted geodesic interpolation. In some cases, mean-field approximations can produce fused states by averaging in tangent spaces, whereas variational inference introduces probabilistic distributions over the fused states. Attention mechanisms may also be applied, allowing the system to emphasize certain inputs—for example, weighting content near the optical center of a camera more heavily than peripheral regions where distortion is likely.

Architectures for correlation networks likewise vary. Dense fully connected networks can directly map between all camera pairs, but more efficient approaches may use sparse attention to focus on the most relevant pairs, or graph neural networks that model inter-camera relationships as graph edges with message-passing to propagate information. Generative adversarial networks provide yet another option, where discriminators trained to distinguish real from synthetic scenes help refine the quality of reconstructions.

Path planning for geodesic traversal can also be selected to suit system requirements. Discretized manifolds may employ classical algorithms such as Dijkstra's or A-star, while continuous manifolds can benefit from rapidly-exploring random trees that sample stochastic trajectories. In mission-critical contexts where near-term optimization is essential, model predictive control may be used to generate finite-horizon trajectories with a receding planning window. Each of these approaches balances optimality with computational efficiency, giving implementers a range of tools to adapt to varying workloads and latency budgets.

Predictive completion can draw on evidence sources beyond the geometric priors, rollout simulations, and historical kernels described earlier. Semantic priors derived from object detection or scene classification models may bias reconstructions toward content that matches plausible categories. Physical priors introduced through physics engines can account for lighting, shadows, or material properties. In other cases, social priors from human activity models may forecast likely pedestrian or vehicle behaviors, while temporal priors from motion prediction networks extrapolate future states from observed trajectories. Together, these additional evidence sources enrich the plausibility of reconstructions by grounding them in domain-specific knowledge.

The Bayesian fusion stage is also adaptable. Although Beta distributions provide a compact way to represent binary outcomes, alternative posterior families may be used when the task demands richer structure. For example, Dirichlet distributions can represent categorical hypotheses when multiple classes of reconstructions are possible, Gaussian processes may be applied to model continuous quality metrics, and mixture models allow for multimodal posterior distributions when several distinct but plausible reconstructions coexist.

At the governance level, distributed PCM deployments can employ a range of consistency mechanisms. Some systems may rely on consensus protocols that require agreement from a majority of nodes before fused alerts are accepted, while more resilient configurations implement Byzantine fault tolerance to safeguard against malicious or faulty nodes. Immutable provenance can also be enforced through blockchain-style recordkeeping, where fusion operations and alert propagation events are logged in audit trails that resist tampering.

Learning during off-task cycles can follow different replay strategies depending on operational objectives. Uniform replay simply samples past trajectories at equal probability, while prioritized replay focuses attention on trajectories that exhibited high temporal-difference errors or unexpected outcomes. Hindsight replay allows archived trajectories to be relabeled with counterfactual goals, effectively learning from failures, and curriculum replay introduces progressively harder examples over time to encourage robust learning.

For operators, system outputs may be delivered through interfaces that adapt to different sensory modalities. Visual displays can show decoded imagery augmented with overlays, while textual summaries present alerts in natural language. In parallel, auditory alerts provide non-visual notifications, and haptic feedback—such as vibration patterns—can be used to signal uncertainty or indicate compression pressure. Multimodal presentations combine these channels to create redundancy and support accessibility in demanding operational contexts.

A complete implementation integrates all of these components within a cohesive computing environment. Camera input interfaces may receive video streams from physical cameras via standard protocols such as RTSP or RTMP, or through proprietary streaming formats. These inputs undergo protocol translation, buffering, and synchronization to ensure temporally aligned delivery to the encoders. Downstream, GPU clusters handle the heavy computational tasks of parallel encoding, rollout simulation, and rendering, connected through high-bandwidth interconnects such as NVLink or InfiniBand to facilitate rapid data transfer. CPU clusters manage orchestration and scheduling, while memory hierarchies balance bandwidth and capacity by pairing GPU-attached high-bandwidth memory for active latent representations with network-attached storage for archived trajectories.

Supporting infrastructure ensures responsiveness and security. Local-area networks may connect cameras and compute within a single site, while wide-area networks link federated PCM nodes across geographic regions. Quality-of-service mechanisms prioritize synchronization traffic to sustain sub-100 millisecond latencies, and encryption safeguards transmitted parameters such as posterior updates and divergence indices. For persistence, solid-state drives maintain active manifold representations that demand low-latency access, while object storage archives longer-term trajectories accessed during sleep cycles. Compression is applied where appropriate—lossless for critical provenance data and lossy for archived video when acceptable—and retention policies can automatically expire older data based on age, relevance, or storage constraints.

The software architecture may be organized into microservices, with each service implementing a specific functional component such as encoders, fusion operators, or correlation networks. Deployment, scaling, and failover can be managed through service orchestration frameworks such as Kubernetes, while message queues provide decoupling between services to support asynchronous processing and buffer load spikes. Application programming interfaces expose these services for integration with external platforms, including security management systems and video management systems, allowing the fusion framework to be incorporated into broader operational environments.

System health and performance are maintained through monitoring and observability infrastructure. Metrics collection captures latency distributions, throughput rates, error frequencies, and resource utilization. Distributed tracing may be applied to follow individual alerts as they pass through the processing pipeline, making it possible to diagnose bottlenecks or inefficiencies. Complementing this, alerting subsystems notify operators of anomalies such as divergence spikes, latency threshold violations, or abnormal resource usage, ensuring that the fusion framework operates reliably in real time.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “Lorentzian autoencoder” refers to a neural network encoder-decoder architecture configured to map video streams into latent manifolds that preserve spatiotemporal coherence using time-like latent axes and Lorentzian geometric structure.

As used herein, “fast manifold” refers to a per-camera latent space representation generated by a Lorentzian autoencoder, wherein temporal ordering and causal structure are preserved for a single camera stream.

As used herein, “mesoscale manifold” (or “fused manifold”) refers to a latent space representation in which multiple fast manifolds are aligned and fused through geometric registration and interpolation to create a unified scene representation.

As used herein, “slow manifold” refers to a higher-level latent space representation in which recurrent motifs or patterns consolidated from multiple fused manifolds are stored as schemas for long-term structural reasoning.

As used herein, “geodesic trajectory” refers to a path computed within a latent manifold that represents continuous navigation across viewpoint and scale dimensions, determined by minimizing an action functional that balances kinetic energy, compression pressure, and goal potential.

As used herein, “compression pressure” refers to a scalar field derived from local curvature of a latent manifold that quantifies semantic density, wherein higher compression pressure corresponds to regions with denser or more complex semantic content.

As used herein, “goal potential field” refers to a field defined within a latent manifold that biases geodesic trajectory computation toward user-specified target regions or scales.

As used herein, “correlation network” refers to a computational system configured to analyze redundancies and relationships between multiple camera views in latent space to restore occluded or degraded regions by synthesizing consistent representations.

As used herein, “proto-scene cluster” refers to a latent-space grouping of states across multiple fast manifolds that exceed a density threshold, indicating convergence of camera perspectives on a common scene element.

As used herein, “symbolic anchor” refers to a semantic label linked to a latent state or trajectory within a manifold, enabling alignment, retrieval, and integration with higher-level cognitive reasoning processes.

As used herein, “fiber map” refers to a transformation that transports latent representations such as alert objects or trajectories between different mesoscale manifolds maintained by federated nodes.

As used herein, “divergence index” refers to a measure of semantic drift between transported and locally computed latent representations, computed as a geodesic distance within a fused manifold.

As used herein, “autonomy envelope” refers to a defined threshold for divergence indices within which local nodes maintain autonomy, and beyond which reconciliation or doctrinal constraints are applied.

As used herein, “schema” refers to a consolidated structural regularity stored in the slow manifold that encodes recurring patterns of scene dynamics, occlusion, or object behavior, usable for prediction and reasoning.

As used herein, “counterfactual trajectory” refers to a perturbed path within a manifold derived by applying deviations in tangent space to an existing fused trajectory, enabling generation of alternative or hypothetical viewpoints.

As used herein, “posterior probability” refers to a probability estimate computed using Bayesian fusion of geometric priors, rollout simulations, and historical kernels, characterizing confidence in a reconstructed or predicted viewpoint.

As used herein, “scene fusion card” refers to a structured human-machine interface element that presents fused alert objects together with posterior probability estimates, provenance information, doctrinal tags, and recommended operator actions.

### Conceptual Architecture of a Real-time Multi-Camera Latent Fusion System

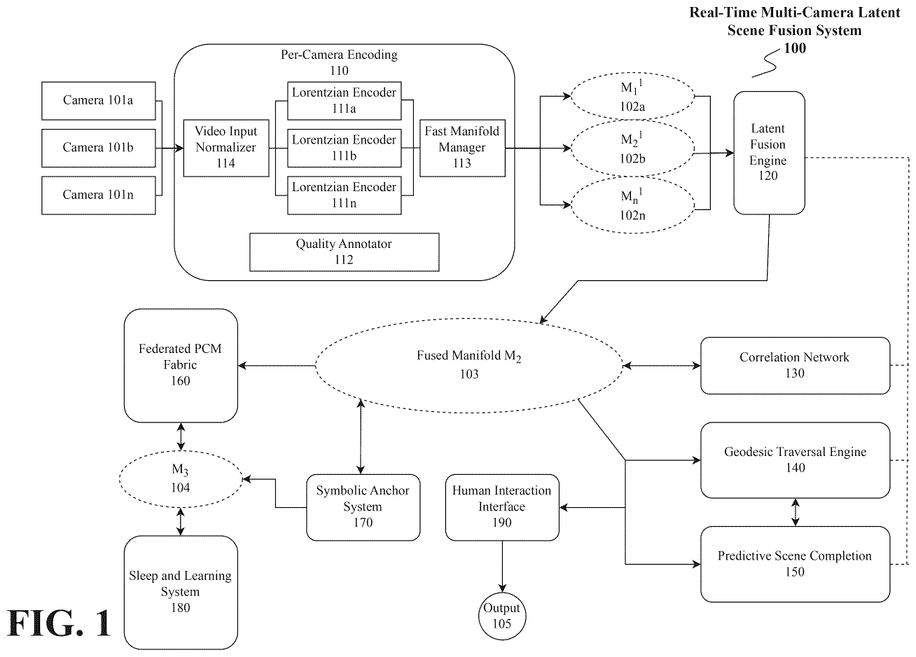

FIG. 1 is a block diagram illustrating an exemplary architecture of a real-time multi-camera latent scene fusion system 100, in an embodiment. System 100 is configured to transform heterogeneous video streams from multiple cameras into a unified latent representation that supports continuous navigation across both magnification scale and camera viewpoint. This enables substantially seamless zoom operations that traverse perspective boundaries with reduced perceptual discontinuities. Unlike conventional pixel-space stitching approaches, which may introduce parallax artifacts and occlusion gaps, system 100 operates in latent space using geometric operators that are configured to maintain spatiotemporal coherence while also supporting predictive reconstruction of regions not directly observed by any camera.

In the illustrated embodiment, system 100 receives video streams from a plurality of cameras 101a-n, where each camera captures a different viewpoint of a scene with potentially heterogeneous resolutions, frame rates, and spectral characteristics. Raw video feeds from cameras 101a-n are directed to a video input normalizer 114, which may apply resolution scaling, temporal alignment, and radiometric calibration to produce normalized streams suitable for encoding. The normalized streams from video input normalizer 114 are transmitted to a per-camera encoding system 110 that transforms pixel-space video into latent-space representations while promoting preservation of spatiotemporal coherence.

Within per-camera encoding system 110, each normalized camera stream is processed by a corresponding Lorentzian autoencoder from a bank of Lorentzian autoencoders 111a-n. Each Lorentzian autoencoder 111a-n encodes its respective camera stream into a latent trajectory within a corresponding fast manifold 102a-n. Fast manifolds 102a-n are configured to retain time-like latent axes and three-dimensional convolutional structure to promote temporal ordering and causal relationships within encoded representations. A quality annotator 112 computes evidence scores for each encoded stream, characterizing reliability based on factors such as encoder fidelity, signal quality, and noise conditions. These quality scores are attached to the latent trajectories to enable quality-weighted contributions during fusion operations. A fast manifold manager 113 maintains the per-camera latent manifolds 102a-n as geometric structures where distances and paths correspond to perceptual and semantic relationships within individual camera views.

The fast manifolds 102a-n with their associated quality scores are transmitted to a latent fusion engine 120, which registers and aligns these manifolds into a unified representation. A registration engine within latent fusion engine 120 computes registration maps between pairs of fast manifolds to align geometric structures by minimizing cross-view distortion. Registration may be constrained by symbolic anchors and known camera geometry to produce consistent cross-view correspondences. A weighted geodesic interpolator implements a fusion operator that aligns latent trajectories across viewpoints through weighted geodesic interpolation, where weights are proportional to quality scores from quality annotator 112. The weighted interpolation produces fused trajectories that integrate information from multiple camera perspectives. A density estimator applies kernel density estimation within the fused representation to detect proto-scene clusters, where regions exceeding density thresholds form proto-scene objects representing areas where multiple camera views converge on similar latent representations. A projection engine projects these proto-scene clusters into fused manifold 103, enriching them with doctrinal tags, provenance metadata identifying contributing cameras and time intervals, and reasoning pathways capturing logical dependencies.

Fused manifold 103 serves as a unified mesoscale representation that supports downstream processing by multiple specialized systems. A correlation and restoration network 130 enhances fused manifold by exploiting redundancies between camera views. A cross-view correlation analyzer identifies redundancies that enable information captured by one camera to inform reconstruction of regions occluded or degraded in another camera. An occlusion handler is configured to reconstruct hidden regions using multi-view geometry and cross-camera correlations, operating in latent space to support geometric consistency with observed portions of the scene. A detail synthesizer may generate plausible missing information to support visual continuity during zoom transitions, creating synthetic details that remain consistent with the semantic and geometric context of surrounding content. A coherence validator checks restored content across viewpoint transitions to reduce the risk that synthesized or restored regions introduce perceptual discontinuities or semantic contradictions. The enhanced fused manifold representation is returned to fused manifold 103 for use by other systems.

A geodesic traversal and continuous zoom engine 140 enables continuous navigation through fused manifold 103 across both scale and viewpoint dimensions. A multi-axis path planner computes geodesic trajectories through fused manifold 103 parameterized by a zoom variable spanning both magnification scale and camera perspective axes. A compression pressure field computer derives compression pressure from Ricci curvature of fused manifold 103, where high compression pressure in semantically dense regions may impose greater traversal costs. A goal potential field generator creates goal potential fields from user zoom requests, encoding desired regions and scales as attractive potentials that bias traversal toward user-specified targets. A trajectory optimizer minimizes a cognitive action functional that balances kinetic energy of attention motion, compression pressure, and goal potential to produce trajectories providing efficient navigation while accommodating perceptual effort required to traverse regions of varying semantic density. A real-time decoder renders views along computed geodesic paths, transforming latent-space geometric structures back into observable pixel-space outputs with latency configured to support operation on the order of less than approximately 100 milliseconds.

A predictive scene completion system 150 synthesizes views not directly captured by any camera, enabling zoom into occluded or unmonitored regions. A geometric prior computer calculates reachability priors based on policy-aligned geodesic distance to hidden regions, accumulated geodesic curvature along trajectories, and compression pressure, providing a structured measure of reconstruction feasibility. A GPU rollout engine simulates short-horizon trajectories in parallel following learned transition operators with stochastic perturbations biased toward occlusion conditions, where each rollout terminates in success or failure to yield Bernoulli outcomes with importance weights. A historical kernel estimator weights past outcomes by geodesic similarity between states and policy similarity, capturing recurring occlusion patterns and typical reconstruction outcomes in comparable environments. A Bayesian fusion engine combines evidence from geometric priors, rollout simulations, and historical outcomes into a Beta posterior distribution over reconstruction success, where posterior means provide central probability estimates and posterior quantiles define credible intervals characterizing uncertainty. A counterfactual generator 155 synthesizes alternate viewpoints by perturbing fused trajectories in tangent space and decoding the perturbed trajectories into synthetic perspectives representing behind-object completions, hypothesized camera angles, or interpolated scene expansions. Gating logic is configured to determine disposition of reconstructions based on posterior probability thresholds, integrating reconstructions above an upper threshold, filtering those below a lower threshold, and escalating intermediate cases for operator review.

Output from geodesic traversal and continuous zoom engine 140 and predictive scene completion system 150 is transmitted to real-time decoder, which produces rendered video output 105.

This output 105 is presented through a human interaction interface 190 that provides structured alerts and interactive controls. A scene fusion card generator creates structured cards for each fused alert including posterior probability with credible intervals, provenance traces listing contributing cameras with encoder confidences, fused view snapshots with overlays marking high-curvature regions, doctrinal tags, and recommended operator actions. A credible interval visualizer 192 displays posterior uncertainty as probability bars with shading representing percentile ranges, communicating epistemic uncertainty to distinguish higher-confidence scenarios from more ambiguous cases requiring review. An interactive zoom controller supports pinch or slider controls for magnification, drag or directional input for cross-camera transitions, and overlays of symbolic anchors that remain consistent across zoom levels, with latency configured to support responsiveness on the order of less than approximately 100 milliseconds. A counterfactual explainability engine generates what-if visualizations by perturbing trajectories and displaying decoded alternate trajectories alongside provenance and probability estimates, enabling operators to explore alternative perspectives or visualize occluded regions. Operator decisions are fed back through human interaction interface 190 to update system state, where accepted recommendations, overrides, or annotations are stored as trajectory-outcome pairs that adjust posterior parameters and reinforce relevant schemas.

The system further comprises a federated PCM fabric and governance system 160 that enables multiple distributed instances to maintain consistent fused scenes without centralizing raw data. A fiber map manager handles fiber maps that transport alert objects and fused trajectories across PCM nodes without exchanging raw video streams. A divergence index calculator computes divergence indices quantifying cross-node semantic drift by measuring geodesic distance between transported and locally computed representations. An autonomy envelope monitor tracks divergence against acceptable thresholds, supporting local autonomy when divergence remains within bounds and initiating reconciliation when thresholds are exceeded. Reconciliation may be achieved by minimizing a collective divergence functional through distributed gradient updates that align alert semantics across the federation, where weights reflect trust relationships, network topology, or doctrinal priorities. A supervisory manifold 104 is configured to apply doctrinal constraints by projecting alerts into constraint manifolds when autonomy envelopes are exceeded, embedding policy requirements such as safety overrides, human-in-loop involvement, or classification constraints. A federated synchronization protocol exchanges posterior parameters, doctrinal tags, and divergence metrics across nodes in cycles that may execute in less than approximately 200 milliseconds across wide-area networks, maintaining consistency without transmitting raw video.

A symbolic anchor system 170 annotates fused trajectories with semantic tags that link labels such as object identifiers or event descriptors to latent states at specific time points. A symbolic anchor manager maintains anchor sets enabling bi-directional retrieval between semantic queries and latent representations. A PCM integration interface provides integration points with PCM thought caches, allowing fused visual representations to participate in broader cognitive reasoning processes.

A sleep and learning system 180 operates during idle cycles to refine system performance through replay, recalibration, and schema consolidation. A trajectory replay engine replays archived fused trajectories geodesically to condense scene dynamics into minimal-action summaries that expose redundancies, anomalies, and alignment patterns not visible during real-time processing. A threshold recalibrator adapts alert and fusion thresholds based on compression pressure within fused manifold 103, raising thresholds in over-fused or noisy regions to suppress spurious alerts and lowering thresholds in regions with low density and high curvature to capture subtle correlations. A posterior archive updater evolves posterior parameters using archived outcomes weighted by geodesic similarity to current operating contexts, supporting predictive completion that adapts to long-run statistics accumulated across many fusion episodes. A cross-view recombination engine performs dreaming operations at slow manifold 104, where recurrent motifs consolidate into schemas through stochastic geodesic recombination of archived trajectories, generating counterfactual fusions such as interpolations between different camera types that may densify latent structure and improve generalization to novel viewpoints. Consolidated schemas are stored in slow manifold 104 for use in subsequent operations.

Data flow through the system proceeds from raw camera feeds through multiple stages of transformation and enhancement. Raw video streams from cameras 101a-n, which may differ in resolution, frame rate, orientation, and spectral characteristics, are first received by video input normalizer 114 where they undergo resolution scaling to establish consistent spatial dimensions, temporal alignment to synchronize frame timing across heterogeneous capture rates, and radiometric calibration to normalize color spaces and intensity ranges. The normalized streams are then distributed to corresponding Lorentzian autoencoders 111a-n within per-camera encoding system 110, where each stream is independently encoded into a latent trajectory within its corresponding fast manifold 102a-n while promoting spatiotemporal coherence through time-like latent axes. Concurrently, quality annotator 112 computes evidence scores for each encoded stream based on encoder fidelity and signal characteristics, attaching these scores to the latent trajectories to enable quality-weighted processing in subsequent stages.

The per-camera fast manifolds 102a-n with their quality annotations are transmitted to latent fusion engine 120, where registration engine computes pairwise registration maps that align geometric structures across manifolds by minimizing cross-view distortion subject to symbolic anchor constraints and known camera geometry. Weighted geodesic interpolator then fuses the registered manifolds through weighted geodesic interpolation that incorporates quality scores, producing unified trajectories that integrate multi-perspective information into fused manifold 103. Within this fusion process, density estimator applies kernel density estimation to identify proto-scene clusters where multiple camera views converge, and projection engine projects these clusters into fused manifold 103 while enriching them with doctrinal tags, provenance metadata, and reasoning pathways.

The initial fused representation in fused manifold 103 may be enhanced through two parallel pathways. Correlation and restoration network 130 receives the fused manifold and analyzes it through cross-view correlation analyzer to identify redundancies between camera perspectives, enabling occlusion handler to reconstruct regions hidden in some views but visible in others using multi-view geometry. Detail synthesizer generates plausible content for regions requiring visual continuity during zoom operations, and coherence validator verifies that all synthesized or restored content supports semantic consistency across viewpoint transitions. The enhanced representation is reintegrated into fused manifold 103. Simultaneously, predictive scene completion system 150 operates on fused manifold 103 to synthesize views not captured by any camera. Geometric prior computer calculates feasibility estimates based on manifold geometry, GPU rollout engine executes parallel simulations to gather empirical evidence about reconstruction plausibility, historical kernel estimator queries archived outcomes from similar contexts, and Bayesian fusion engine 154 combines these evidence sources into posterior probability distributions characterizing reconstruction confidence. Counterfactual generator synthesizes alternate viewpoints through tangent space perturbations, and gating logic determines whether to integrate, escalate, or filter reconstructions based on posterior thresholds.

Following enhancement and predictive completion, user navigation requests trigger geodesic traversal and continuous zoom engine 140 to compute traversal paths through fused manifold 103. Multi-axis path planner receives user-specified regions and scales, while compression pressure field computer derives pressure fields from local curvature and goal potential field generator encodes user targets as attractive potentials. Trajectory optimizer minimizes the cognitive action functional balancing kinetic energy, compression pressure, and goal potential to produce geodesic trajectories that span both magnification scale and camera perspective axes. These trajectories are transmitted to real-time decoder, which transforms latent representations along the paths back into pixel-space video frames, incorporating both observed content from the original cameras and synthesized content from predictive completion system 150 when posterior probabilities exceed acceptance thresholds.

Rendered output from real-time decoder is presented through human interaction interface 190, where scene fusion card generator constructs structured alerts containing posterior probabilities with credible intervals, provenance traces, view snapshots with curvature overlays, and doctrinal tags. Credible interval visualizer displays uncertainty quantification, interactive zoom controller provides responsive navigation controls with latency configured to support operation on the order of less than approximately 100 milliseconds, and counterfactual explainability engine generates what-if visualizations for operator exploration. Operator responses including acceptances, overrides, and annotations flow back through human interaction interface 190 as trajectory-outcome pairs that update posterior parameters in Bayesian fusion engine and reinforce schemas in slow manifold 104.

Throughout real-time operation, federated PCM fabric and governance system 160 supports consistency across distributed deployments. Fiber map manager transports alert objects and trajectories between nodes without transmitting raw video, divergence index calculator quantifies semantic drift between node representations, and autonomy envelope monitor initiates reconciliation through distributed gradient descent when divergence exceeds thresholds. Federated synchronization protocol exchanges only posterior parameters, doctrinal tags, and divergence metrics in cycles that may execute in less than approximately 200 milliseconds, while supervisory manifold 104 applies doctrinal constraints when autonomy envelopes are exceeded. During idle periods, sleep and learning system 180 refines performance through trajectory replay engine which condenses archived paths into minimal-action summaries, threshold recalibrator which adapts density and fusion thresholds based on compression pressure patterns, posterior archive updater which evolves Bayesian parameters from historical outcomes, and cross-view recombination engine which performs stochastic geodesic recombination to consolidate recurring patterns into reusable schemas stored in slow manifold 104. The complete architecture is configured to support end-to-end latency on the order of less than approximately 100 milliseconds for continuous zoom operations, while promoting semantic and temporal coherence across heterogeneous camera arrays and enabling traversal across both scale and viewpoint dimensions through unified latent-space representations.

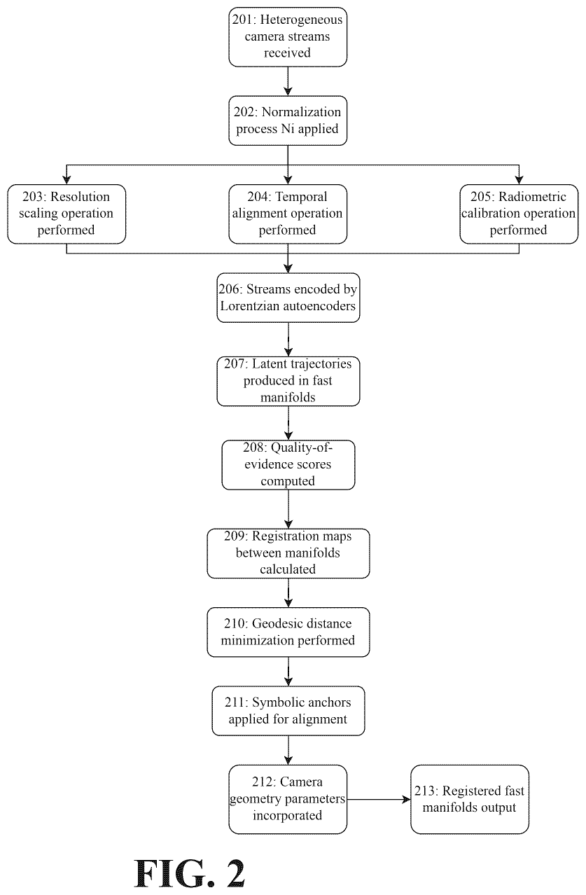

FIG. 2 is a flow diagram illustrating exemplary multi-camera encoding and registration of a real-time multi-camera latent scene fusion system, in an embodiment. The process begins when the system receives heterogeneous camera streams xi(t) from a plurality of cameras 101a-n, where each camera operates with different resolutions, frame rates, or spectral characteristics 201. Each camera stream is directed to a video input normalizer 114 of per-camera encoding system 110, which applies a normalization process Ni adapted to that camera's characteristics 202. The normalization process includes resolution scaling 203 to establish consistent spatial dimensions, temporal alignment 204 to synchronize frame timing across capture rates, and radiometric calibration 205 to standardize color spaces and intensity ranges. The normalized streams are then encoded by Lorentzian autoencoders 111a-n of per-camera encoding system 110, with one encoder assigned to each camera stream 206. Each Lorentzian autoencoder Ei produces a latent trajectory zi(t) within a corresponding fast manifold Mi¹, which preserves spatiotemporal coherence through time-like latent axes 207 and is maintained by fast manifold manager 113. Concurrently, a quality annotator 112 of per-camera encoding system 110 computes quality-of-evidence scores qi(t) for each encoded stream, based on encoder fidelity, signal quality, and noise conditions 208.

Once the fast manifolds are generated with their associated quality scores, a registration engine 121 of latent fusion engine 120 computes registration maps Rij between fast manifolds 209. The registration process minimizes cross-view distortion by calculating geodesic distances between latent states across different camera perspectives 210. Registration is constrained by symbolic anchors maintained within symbolic anchor system 170, linking latent states to semantic labels for semantic consistency 211, and is further refined using known camera geometry parameters such as intrinsic and extrinsic matrices when available 212. The process outputs the registered fast manifolds with their quality annotations 213, which are then available for fusion into a unified mesoscale manifold M2.

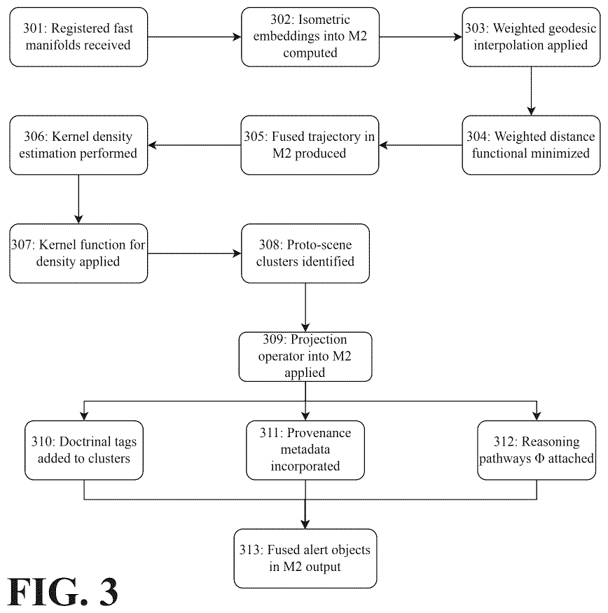

FIG. 3 is a flow diagram illustrating exemplary latent fusion of a real-time multi-camera latent scene fusion system, in an embodiment. The process begins when latent fusion engine 120 receives registered fast manifolds 102a-n along with their associated quality-of-evidence scores computed by quality annotator 112 of per-camera encoding system 110, where each fast manifold Mi¹ corresponds to a distinct camera perspective 301. Latent fusion engine 120 computes isometric embeddings φi that map each fast manifold Mi¹ into mesoscale manifold M2 103 while preserving geometric relationships 302. Latent fusion engine 120 applies weighted geodesic interpolation to align latent trajectories across viewpoints 303. The interpolation minimizes a weighted distance functional of the form Σ wi dM2(z, φi(zi(t)))² where weights wi are proportional to quality scores qi(t) and dM2 represents geodesic distance in the mesoscale manifold 304. The minimization produces a fused trajectory zf(t) in mesoscale manifold M2 103 that integrates information from multiple camera perspectives in a quality-weighted manner 305.

Latent fusion engine 120 performs kernel density estimation to compute a density function ρ(z) across the fused manifold 306. A kernel function of the form K(z,y)=exp(−dM2(z,y)²/2σ²) is applied, where σ is a bandwidth parameter controlling the spatial extent of density contributions 307. Latent fusion engine 120 identifies proto-scene clusters as regions where computed density exceeds a threshold value, with the clusters representing areas where multiple camera views converge on similar latent representations 308. Latent fusion engine 120 applies a projection operator π that maps collections of fast manifold states into mesoscale manifold M2 103 309.

Each projected proto-scene cluster is enriched with doctrinal tags encoding policy constraints, operational guidelines, and semantic classifications 310. Provenance metadata is added to track which cameras and time intervals contributed to each fused object 311. Reasoning pathways Φ are attached to capture logical dependencies and inference chains supporting object classifications 312. The process outputs fused alert objects Am residing in unified mesoscale manifold M2 103 enriched with doctrinal tags, provenance metadata, and reasoning pathways 313.

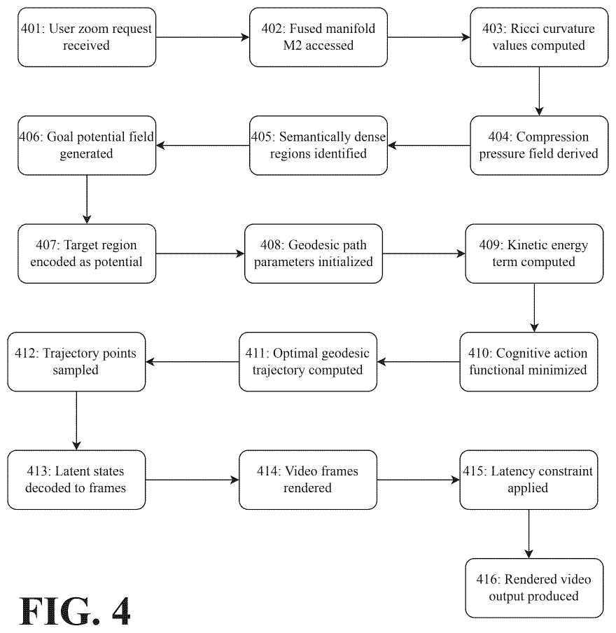

FIG. 4 is a flow diagram illustrating exemplary geodesic traversal and continuous zoom operations of a real-time multi-camera latent scene fusion system, in an embodiment. The process begins when geodesic traversal and continuous zoom engine 140 receives a user zoom request specifying a target region R and desired scale α 401. Engine 140 accesses fused manifold M2 103 containing the unified latent representation of the multi-camera scene 402. Engine 140 computes Ricci curvature values across local regions of fused manifold M2 103 to characterize geometric properties of the latent space 403. From the computed curvature values, engine 140 derives a compression pressure field P(γ(s)), where pressure magnitude reflects semantic density of the represented content 404. Engine 140 identifies semantically dense regions that impose greater traversal cost during navigation through the manifold 405.

Engine 140 generates a goal potential field Φ(γ(s)) based on the user-specified target region R and scale α 406. The goal potential encodes the desired region and scale as an attractive potential that biases trajectory computation toward the user's intended destination 407. Engine 140 initializes parameters for geodesic path computation, including starting position and zoom variable s that spans both scale and viewpoint axes 408. Engine 140 computes the kinetic energy term ∥\dot{γ}(s)∥²g2 representing the energy cost of attention motion through the manifold according to Riemannian metric g2 409. Engine 140 minimizes a cognitive action functional that integrates the kinetic energy term, the compression pressure field, and the goal potential field over the traversal path 410. Engine 140 computes an optimal geodesic trajectory γ*(s) that spans both magnification scale and camera viewpoint axes while balancing efficiency against the semantic structure of the scene 411.

Engine 140 samples discrete points along computed geodesic trajectory γ*(s) for decoding into observable video frames 412. Engine 140 decodes the latent representations at each sampled point back into pixel-space video frames 413. Engine 140 renders the decoded video frames to produce visual output that smoothly traverses the requested scale and viewpoint transition 414. Engine 140 applies a latency constraint so that the process from user request to rendered output completes in less than approximately 100 milliseconds 415. The process outputs rendered video enabling continuous navigation across both magnification scale and camera perspective without perceptual discontinuities 416.

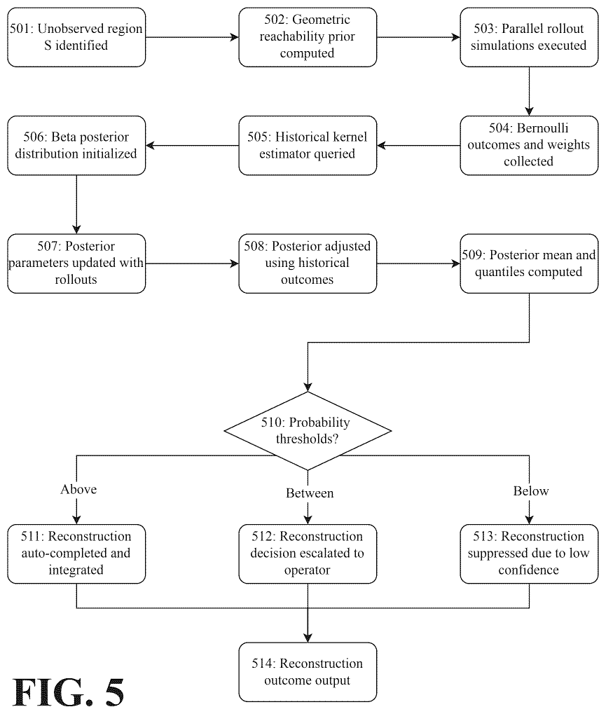

FIG. 5 is a flow diagram illustrating exemplary predictive scene completion operations of a real-time multi-camera latent scene fusion system, in an embodiment. The process begins when predictive scene completion system 150 identifies an unobserved region S requiring reconstruction, such as a region occluded by foreground objects or not covered by any camera in the array 501. System 150 computes a geometric reachability prior φπ(x0) based on policy-aligned geodesic distance from current state x0 to the hidden region S, accumulated geodesic curvature along potential trajectories, and compression pressure at the current state 502.

System 150 executes parallel short-horizon trajectory simulations on a graphics processing unit, where each simulation follows learned transition dynamics with stochastic perturbations biased toward occlusion conditions 503. System 150 collects Bernoulli outcomes indicating success or failure for each simulated trajectory, along with importance weights reflecting relevance to the reconstruction task 504. System 150 queries a historical kernel estimator to retrieve past reconstruction outcomes from contexts similar to the current state, with similarity measured by geodesic distance between states and policy similarity 505.

System 150 initializes a Beta posterior distribution pπ(x0) using parameters α and β derived from the geometric reachability prior 506. System 150 updates the posterior parameters by adding the number of successful rollouts to α and the number of failed rollouts to β 507. System 150 adjusts the posterior distribution through Bayesian updating using likelihoods derived from the weighted historical outcomes 508. System 150 computes the posterior mean α/(α+β) as a central probability estimate and computes posterior quantiles to define credible intervals characterizing uncertainty in the reconstruction probability 509.

System 150 applies gating logic by comparing the posterior probability against defined upper and lower thresholds 510. When the posterior probability exceeds the upper threshold, System 150 automatically completes the reconstruction and integrates the synthesized viewpoint into fused manifold M 2 103 511. When the posterior probability falls between the upper and lower thresholds, System 150 escalates the reconstruction decision to a human operator for review 512. When the posterior probability falls below the lower threshold, System 150 suppresses the reconstruction due to insufficient confidence 513. The process outputs either a synthesized viewpoint integrated into the fused scene, an escalation request to human operators, or a suppression decision, depending on reconstruction confidence level 514.

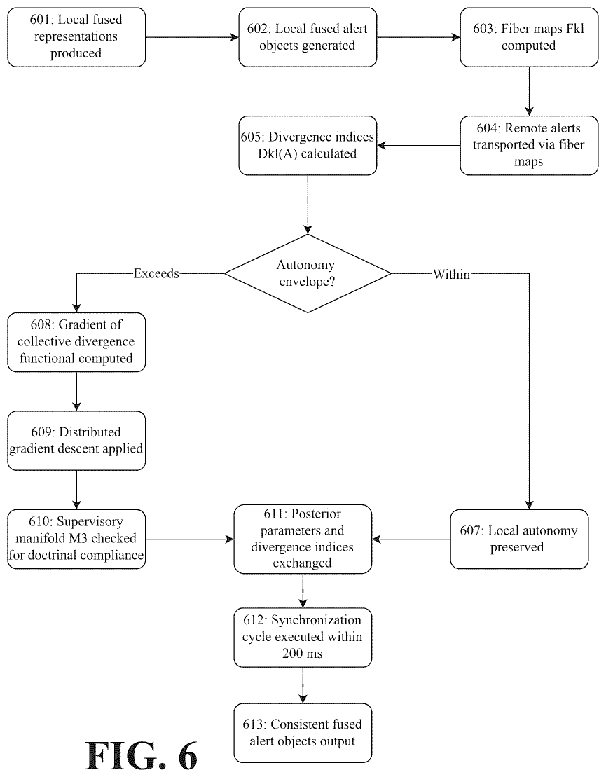

FIG. 6 is a flow diagram illustrating exemplary federated synchronization operations of a real-time multi-camera latent scene fusion system, in an embodiment. The process begins when federated PCM fabric and governance system 160 performs independent scene fusion operations at multiple geographically separated nodes, each producing local fused representations in its respective mesoscale manifold 601. Each node generates fused alert objects representing detected scenes, events, or objects of interest within its coverage area 602.

System 160 computes fiber maps Fkl that describe transformations for transporting alert objects and fused trajectories from one node's mesoscale manifold Ml² to another node's mesoscale manifold Mk² 603. System 160 applies a fiber map to transport a remote alert object into the coordinate system of a local node's manifold, enabling comparison without requiring raw video transmission 604. System 160 calculates a divergence index Dkl(A) for each transported alert by measuring geodesic distance between the transported representation and the locally computed representation of the same scene element 605.

System 160 compares the divergence index against a defined autonomy envelope threshold ϵkl to determine whether local and remote representations remain sufficiently consistent 606. When the divergence index remains within the autonomy envelope threshold, System 160 preserves local autonomy and allows nodes to continue operating independently 607. When the divergence index exceeds the autonomy envelope threshold, System 160 computes the gradient of a collective divergence functional Cfed with respect to the local alert representation 608. System 160 applies distributed gradient descent by updating the local alert representation in the direction that minimizes the collective divergence functional, with step size determined by learning rate η 609.

System 160 checks supervisory manifold M3 104 to confirm that reconciled alerts comply with doctrinal constraints such as safety overrides, human-in-loop requirements, or classification rules 610. System 160 exchanges posterior parameters (α, β), doctrinal tags, and divergence indices with remote nodes, avoiding transmission of raw video data to preserve privacy and reduce bandwidth requirements 611. System 160 executes the synchronization cycle in less than approximately 200 milliseconds across wide-area networks to maintain near-real-time consistency 612. The process outputs consistent fused alert objects across the federation that satisfy both local accuracy requirements and global doctrinal constraints 613.

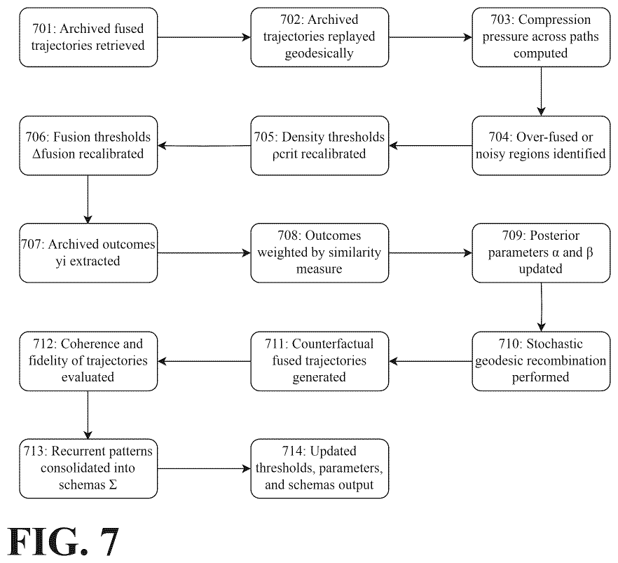

FIG. 7 is a flow diagram illustrating exemplary sleep-state learning and schema consolidation operations of a real-time multi-camera latent scene fusion system, in an embodiment. The process begins when sleep and learning system 180 initiates an idle processing cycle and retrieves archived fused trajectories from storage, each trajectory including outcome labels indicating success or failure of past reconstruction or fusion operations 701. System 180 replays the archived trajectories geodesically by computing minimal-action paths connecting the initial and final states of each trajectory, producing condensed summaries of scene dynamics 702.

System 180 computes compression pressure across the replayed paths by calculating divergence of velocity vector fields within fused manifold M 2 103, where compression pressure quantifies density of information flow through different manifold regions 703. System 180 identifies over-fused or noisy regions characterized by high compression pressure, indicating areas where multiple camera feeds produced redundant or conflicting information 704. System 180 recalibrates density thresholds ρcrit based on observed compression pressure, raising thresholds in regions with excessive pressure to reduce noise sensitivity 705. System 180 recalibrates fusion thresholds Δfusion to suppress spurious alerts in problematic regions while lowering thresholds in sparse regions to capture subtle correlations 706.

System 180 extracts archived outcomes yi associated with each replayed trajectory γi for use in updating probabilistic reconstruction models 707. System 180 weights each archived outcome by a similarity measure w(γi) reflecting geodesic distance between the archived trajectory's context and current operating conditions 708. System 180 updates posterior parameters α and β of the Beta distributions used by predictive scene completion system 150, adding weighted successes to α and weighted failures to β 709.

System 180 performs stochastic geodesic recombination by sampling multiple archived trajectories and generating synthetic interpolations between them using a stochastic recombinator function G 710. System 180 generates counterfactual fused trajectories γdream(t) representing plausible multi-camera scene dynamics not directly observed during real-time operation, such as interpolations between UAV and ground camera perspectives 711. System 180 evaluates coherence and reconstruction fidelity of each synthetic trajectory by measuring compression cost and consistency with learned scene statistics 712.

System 180 consolidates recurrent patterns from both real and synthetic trajectories into reusable schemas Σ stored in slow manifold M3 104, where schemas capture structural regularities such as typical occlusion patterns or motion signatures 713. The process outputs updated density thresholds, recalibrated fusion thresholds, refined posterior parameters for Bayesian reconstruction, and consolidated schemas that improve generalization to novel multi-camera scenarios 714.

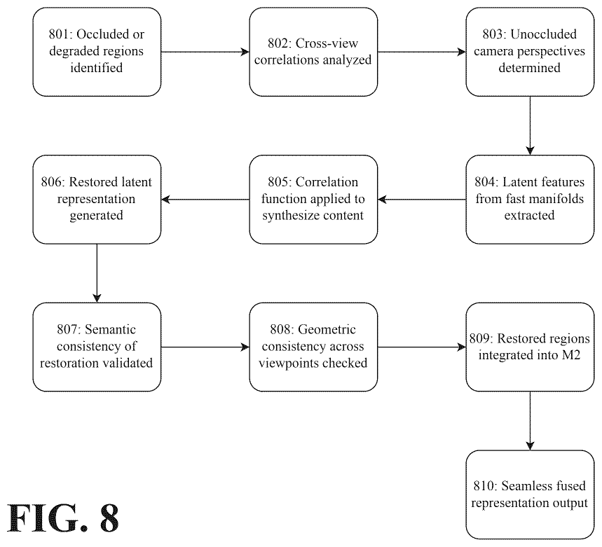

FIG. 8 is a flow diagram illustrating exemplary correlation network restoration operations of a real-time multi-camera latent scene fusion system, in an embodiment. The process begins when correlation and restoration network 130 identifies occluded or degraded regions within fused manifold M2 103, where occlusions may result from foreground objects blocking camera views or signal degradation due to environmental conditions 801. System 130 analyzes cross-view correlations between pairs of cameras to determine which perspectives contain redundant or complementary information about the occluded region 802.

System 130 determines which cameras 101a-n provide unoccluded views of the target region, identifying those with an unobstructed line of sight 803. System 130 extracts corresponding latent features from fast manifolds 102a-n of the selected cameras, retrieving encoded representations that capture the hidden region from alternative viewpoints 804. System 130 applies a correlation function C that uses fused trajectory zf(t) and the collection of per-camera latent states {zi(t)} to synthesize missing content in the occluded region 805.

System 130 generates a restored latent representation \hat{z}f(t) for the occluded region by exploiting multi-view geometry and learned correlations between camera perspectives 806. System 130 validates that the restored content maintains semantic consistency with surrounding observed content in fused manifold M 2 103, confirming alignment with the context of nearby regions 807. System 130 checks geometric consistency of the restored content across viewpoint transitions to verify that reconstruction does not introduce perceptual discontinuities 808. System 130 integrates the restored regions back into fused manifold M2 103, replacing degraded or missing representations with correlation-enhanced reconstructions 809. The process outputs a seamless fused representation in manifold M 2 103 that no longer contains occlusion gaps or degraded regions, having leveraged cross-view redundancy to complete the scene 810.

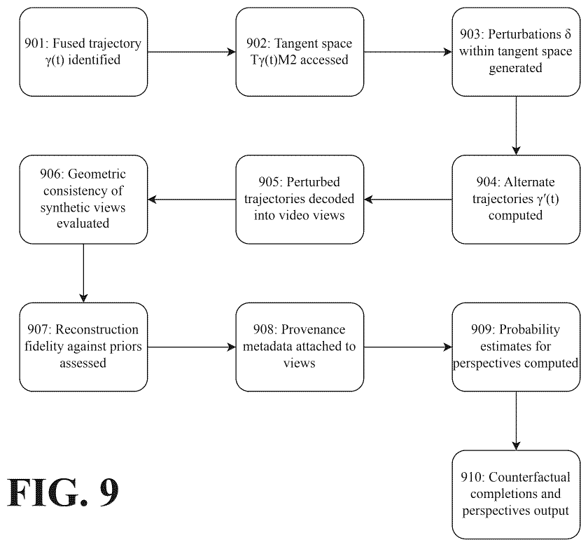

FIG. 9 is a flow diagram illustrating exemplary counterfactual scene expansion operations of a real-time multi-camera latent scene fusion system, in an embodiment. The process begins when predictive scene completion system 150 identifies a fused trajectory γ(t) in mesoscale manifold M2 103 that requires expansion to generate alternative viewpoints not directly captured by any camera in array 101a-n 901. System 150 accesses the tangent space Tγ(t)M2 at one or more points along the trajectory, where the tangent space represents possible local perturbations 902.

System 150 generates perturbations δ within the tangent space, where each perturbation represents a potential deviation from the original trajectory corresponding to an alternative angle, a behind-object perspective, or an interpolated viewpoint 903. System 150 computes alternate trajectories γ′(t) by adding perturbations to the original trajectory according to γ′(t)=γ(t)+δ, producing a family of synthetic paths through the latent manifold 904. System 150 decodes the perturbed trajectories into synthetic video views by applying the decoder of geodesic traversal and continuous zoom engine 140, transforming latent representations back into pixel-space imagery 905.

System 150 evaluates geometric consistency of the synthetic views by verifying that decoded imagery maintains coherent spatial relationships and avoids implausible perspective transformations 906. System 150 assesses reconstruction fidelity by comparing synthetic views against learned scene statistics and natural image priors to confirm plausibility 907. System 150 attaches provenance metadata to each counterfactual view, documenting the source trajectory, applied perturbation, and contributing cameras 908. System 150 computes probability estimates for the synthetic perspectives using the Bayesian fusion framework employed for predictive completion, providing confidence measures for each reconstruction 909. The process outputs behind-object completions and interpolated perspectives that extend scene understanding and enable operators to explore hypothetical views 910.

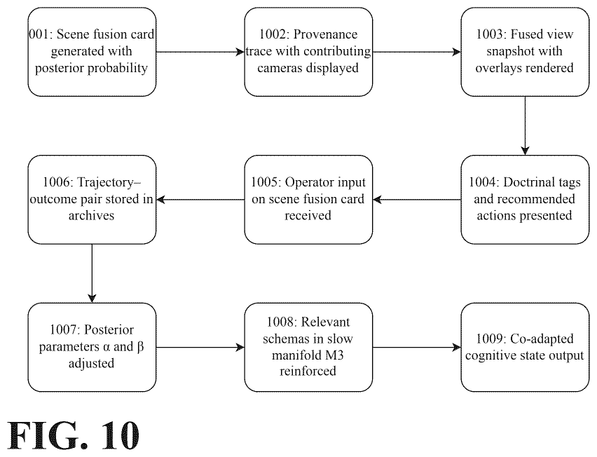

FIG. 10 is a flow diagram illustrating exemplary human interaction and feedback loop operations of a real-time multi-camera latent scene fusion system, in an embodiment. The process begins when human interaction interface 190 generates a scene fusion card for a fused alert object, where the card includes a posterior probability \hat{p}π(x0) computed by predictive scene completion system 150 along with credible intervals defined by posterior quantiles such as the 5th and 95th percentiles 1001. Interface 190 displays a provenance trace on the card listing the contributing cameras 101a-n and their respective encoder confidence scores qi(t) computed by quality annotator 112 1002. Interface 190 renders a fused view snapshot showing the decoded output from geodesic traversal and continuous zoom engine 140, with visual overlays marking high-curvature regions of fused manifold M2 103 1003.

Interface 190 presents doctrinal tags associated with the alert object together with recommended operator actions such as “zoom-in,” “accept auto-completion,” or “escalate for review,” where tags and recommendations originate from enrichment performed by latent fusion engine 120 1004. Interface 190 receives operator input in response to the presented scene fusion card, where the operator may accept the system's recommendation, override it with an alternative action, or annotate the alert with contextual information 1005. Interface 190 stores a trajectory-outcome pair (γ, y) in archives accessible to sleep and learning system 180, where γ represents the fused trajectory associated with the alert and y represents the operator's decision outcome 1006.

Interface 190 triggers adjustment of posterior parameters α and β maintained by predictive scene completion system 150, where accepted recommendations increase α and rejected recommendations increase β, refining probability estimates for future alerts 1007. Interface 190 reinforces relevant schemas in slow manifold M3 104 by increasing the weight of patterns that align with the operator's decision, enabling the system to adapt to operator expertise over time 1008. The process outputs a co-adapted cognitive state in which human input and machine models evolve together, improving calibration to operator preferences and domain-specific requirements 1009.

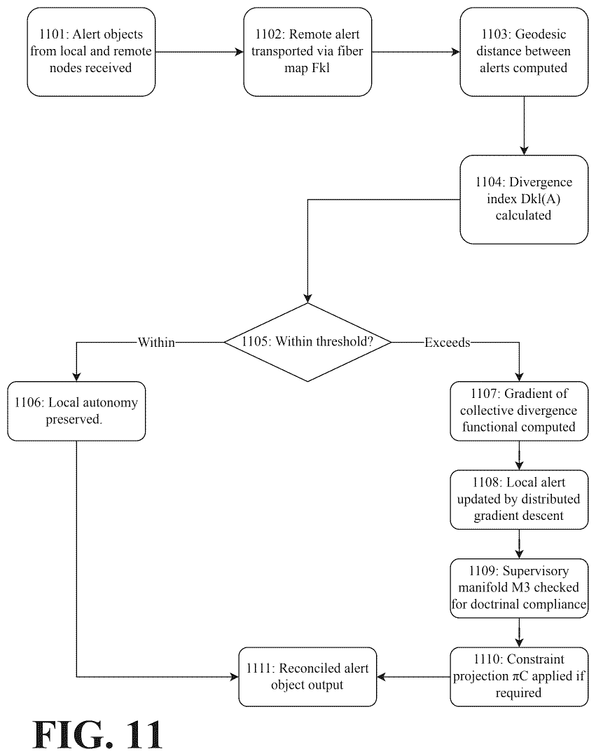

FIG. 11 is a flow diagram illustrating exemplary divergence index calculation and governance operations of a real-time multi-camera latent scene fusion system, in an embodiment. The process begins when federated PCM fabric and governance system 160 receives an alert object A representing the same scene element or event computed independently by a local node and one or more remote nodes operating on geographically separated camera arrays 1101. System 160 applies a fiber map Fkl to transport the remote alert object from the remote node's mesoscale manifold Ml² into the coordinate system of the local node's mesoscale manifold Mk², enabling comparison without requiring transmission of raw video data 1102.

System 160 computes the geodesic distance within local manifold Mk² between the transported remote alert representation Fkl(Al) and the locally computed alert representation Ak 1103. System 160 calculates a divergence index Dkl(A) equal to this geodesic distance, where the index quantifies semantic drift between how different nodes represent the same scene element 1104. System 160 compares the calculated divergence index against a defined autonomy envelope threshold ϵkl that sets the maximum acceptable inconsistency between node representations 1105.

When the divergence index remains within the autonomy envelope threshold, System 160 maintains local autonomy by allowing each node to preserve its own alert representation without reconciliation 1106. When the divergence index exceeds the threshold, System 160 computes the gradient of the collective divergence functional Cfed with respect to the local alert representation Ak 1107. System 160 updates the local alert representation using distributed gradient descent according to Ak←Ak—η∇Ak Cfed, where learning rate η controls the step size and the update reduces collective divergence across the federation 1108.

System 160 checks supervisory manifold M3 104 to confirm whether the reconciled alert representation complies with doctrinal constraints such as safety overrides, human-in-loop requirements, or classification rules embedded in a constraint manifold 1109. If the reconciled alert violates doctrinal requirements, System 160 applies constraint projection πC to project the alert representation into constraint manifold C ⊂ M2, thereby enforcing policy compliance 1110. The process outputs a reconciled alert object that satisfies both cross-node consistency requirements as measured by divergence indices and doctrinal requirements as enforced by supervisory manifold M3 104 1111.

### Exemplary Computing Environment

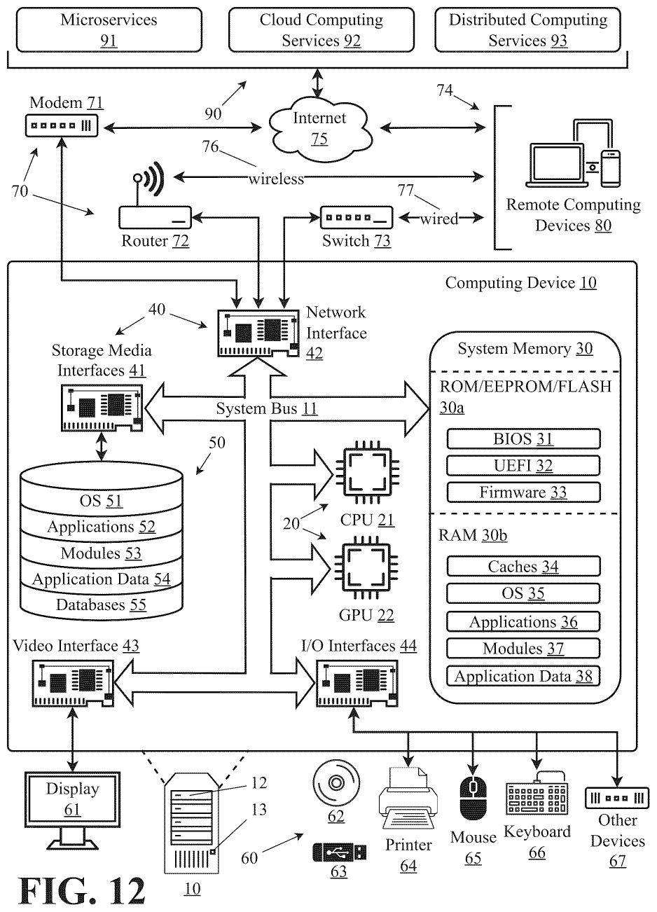

FIG. 12 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as contained.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is contained, which is widely used in software development and deployment. Containerization, particularly with open-source technologies like contained and container orchestration systems like Kubernetes, is a common approach for deploying and managing applications. Containers are created from images, which are lightweight, standalone, and executable packages that include application code, libraries, dependencies, and runtime. Images are often built from a container file or similar, which contains instructions for assembling the image. Container files are configuration files that specify how to build a container image. Systems like Kubernetes natively support contained as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Contained provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
encode video streams from a plurality of cameras into respective latent manifolds using one or more Lorentzian autoencoders, each latent manifold preserving spatiotemporal coherence for a corresponding camera view;
register the latent manifolds from the plurality of cameras into a unified fused manifold through weighted geodesic interpolation that aligns latent trajectories across different viewpoints;
generate compression pressure fields within the fused manifold reflecting semantic density derived from contributions of the plurality of cameras;
compute geodesic trajectories through the fused manifold for continuous traversal across both scale and viewpoint axes, the geodesic trajectories defined by minimization of a functional balancing kinetic energy, compression pressure, and goal potential;
restore occluded or degraded regions in the fused manifold by exploiting cross-view correlations between the plurality of cameras;
compute posterior probabilities for reconstructing unobserved viewpoints using Bayesian fusion of geometric priors, simulated rollouts, and historical outcomes; and
render video output by decoding latent representations along the computed geodesic trajectories, including synthesized content for regions not directly captured by any camera when posterior probabilities exceed a threshold.

2. The computer system of claim 1, wherein encoding video streams from the plurality of cameras comprises computing quality-of-evidence scores for each camera stream and weighting contributions from each camera during registration based on the quality-of-evidence scores.

3. The computer system of claim 1, wherein registering the latent manifolds comprises computing registration maps between pairs of latent manifolds that minimize cross-view distortion constrained by symbolic anchors linking latent states to semantic labels.

4. The computer system of claim 1, wherein computing geodesic trajectories comprises deriving compression pressure from Ricci curvature of the fused manifold such that regions with high semantic density impose greater traversal cost.

5. The computer system of claim 1, wherein computing posterior probabilities comprises executing parallel rollout simulations on a GPU that simulate short-horizon trajectories under stochastic perturbations biased toward occlusion conditions.

6. The computer system of claim 1, wherein the computer system is further configured to execute software instructions that discretize the fused manifold into a landmark graph structure enabling nearest-neighbor queries in logarithmic time for registration and traversal operations.

7. The computer system of claim 1, wherein the computer system is further configured to execute software instructions that exchange posterior parameters and divergence indices with remote computer systems operating on geographically separated camera arrays without exchanging raw video data.

8. The computer system of claim 1, wherein the computer system is further configured to execute software instructions that replay archived geodesic trajectories during idle processing cycles to recalibrate density thresholds and fusion parameters based on compression pressure accumulated across the archived trajectories.

9. A computer-implemented method comprising:
encoding video streams from a plurality of cameras into respective latent manifolds using one or more Lorentzian autoencoders, each latent manifold preserving spatiotemporal coherence for a corresponding camera view;
registering the latent manifolds from the plurality of cameras into a unified fused manifold through weighted geodesic interpolation that aligns latent trajectories across different viewpoints;
generating compression pressure fields within the fused manifold reflecting semantic density derived from contributions of the plurality of cameras;
computing geodesic trajectories through the fused manifold for continuous traversal across both scale and viewpoint axes, the geodesic trajectories defined by minimization of a functional balancing kinetic energy, compression pressure, and goal potential;
restoring occluded or degraded regions in the fused manifold by exploiting cross-view correlations between the plurality of cameras;
computing posterior probabilities for reconstructing unobserved viewpoints using Bayesian fusion of geometric priors, simulated rollouts, and historical outcomes; and
rendering video output by decoding latent representations along the computed geodesic trajectories, including synthesized content for regions not directly captured by any camera when posterior probabilities exceed a threshold.

10. The method of claim 9, wherein encoding video streams from the plurality of cameras comprises computing quality-of-evidence scores for each camera stream and weighting contributions from each camera during registration based on the quality-of-evidence scores.

11. The method of claim 9, wherein registering the latent manifolds comprises computing registration maps between pairs of latent manifolds that minimize cross-view distortion constrained by symbolic anchors linking latent states to semantic labels.

12. The method of claim 9, wherein computing geodesic trajectories comprises deriving compression pressure from Ricci curvature of the fused manifold such that regions with high semantic density impose greater traversal cost.

13. The method of claim 9, wherein computing posterior probabilities comprises executing parallel rollout simulations on a GPU that simulate short-horizon trajectories under stochastic perturbations biased toward occlusion conditions.

14. The method of claim 9, further comprising discretizing the fused manifold into a landmark graph structure enabling nearest-neighbor queries in logarithmic time for registration and traversal operations.

15. The method of claim 9, further comprising exchanging posterior parameters and divergence indices with remote computer systems operating on geographically separated camera arrays without exchanging raw video data.

16. The method of claim 9, further comprising replaying archived geodesic trajectories during idle processing cycles to recalibrate density thresholds and fusion parameters based on compression pressure accumulated across the archived trajectories.
